(19) United States
(12) Patent Application Publication
(10) Pub. No.: US 2026/0253451 A1
(43) Pub. Date: Aug. 27, 2026

(54) SYSTEM

(71) Applicant: SoftBank Group Corp., Tokyo (JP)

(72) Inventor: Kenji ARAI, Tokyo (JP)

(73) Assignee: SoftBank Group Corp., Tokyo (JP)

(21) Appl. No.: 19/541,434

(22) Filed: Feb. 17, 2026

(30) Foreign Application Priority Data
Feb. 21, 2025 (JP) 2025-026999

(51) Int. Cl. G06V 40/20; G06F 3/01; G06V 10/26; G06V 10/62; G06V 10/70; G06V 10/74; G06V 10/764; G06V 10/82; G06V 40/16; G10L 13/027; G10L 13/033

(52) U.S. Cl. CPC G06V 40/28; G06V 10/273; G06V 10/62; G06V 10/764; G06V 10/768; G06V 10/82; G10L 13/027; G10L 13/0335; G06F 3/011; G06F 2203/011; G06V 10/761; G06V 40/174

(57) ABSTRACT

The system according to the embodiment comprises a camera unit, an analysis unit, a conversion unit, and an output unit. The camera unit captures sign language movements. The analysis unit analyzes video captured by the camera unit. The conversion unit converts sign language movements recognized by the analysis unit into language. The output unit outputs the language converted by the conversion unit as voice or text.

### CROSS-REFERENCE TO RELATED APPLICATION

The present application claims priority to and incorporates by reference the entire contents of Japanese Patent Application No. 2025-026999 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult for people who cannot understand sign language to comprehend the content of sign language in real time.

### SUMMARY OF THE INVENTION

The system according to the embodiment comprises a camera unit, an analysis unit, a conversion unit, and an output unit. The camera unit captures sign language movements. The analysis unit analyzes video captured by the camera unit. The conversion unit converts sign language movements recognized by the analysis unit into language. The output unit outputs the language converted by the conversion unit as voice or text.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

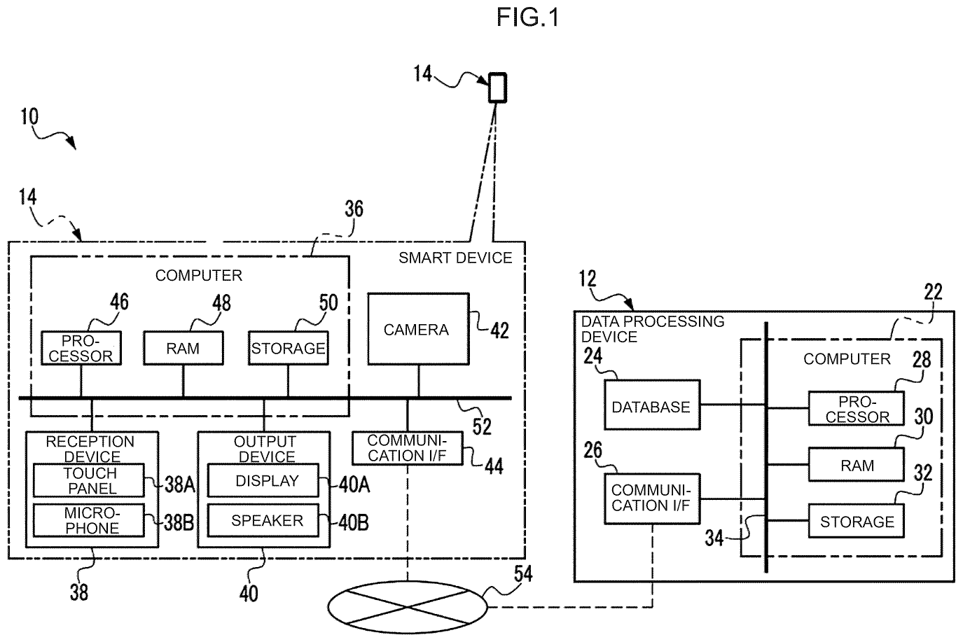

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

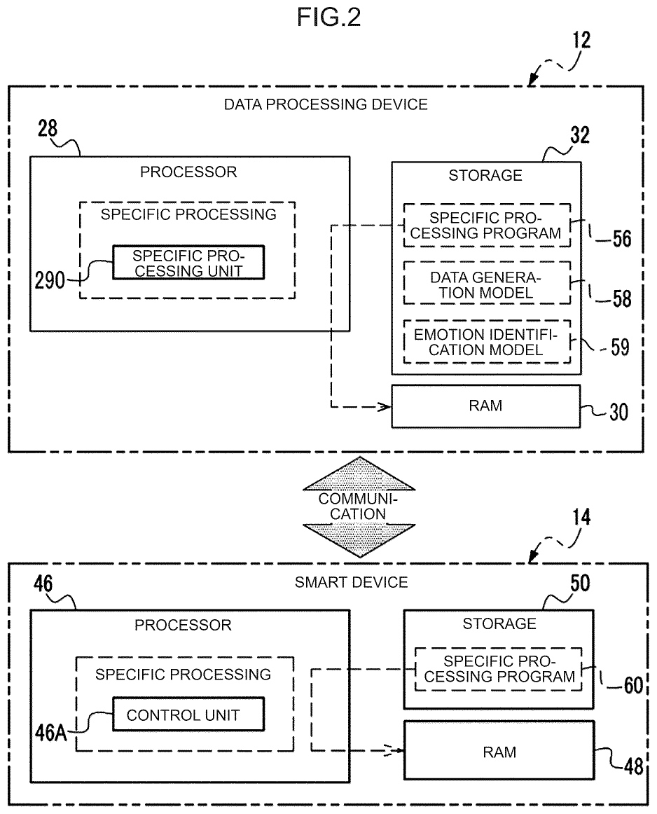

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The sign language conversion system according to the embodiment of the present invention is a system that converts sign language movements into language in real time. This sign language conversion system comprises: a camera unit configured to capture sign language movements; an analysis unit configured to analyze video captured by the camera unit; a conversion unit configured to convert sign language movements recognized by the analysis unit into language; and an output unit configured to output the language converted by the conversion unit as voice or text. For example, the sign language conversion system may use a camera mounted on glasses to capture sign language movements, and AI analyzes the video to recognize the sign language movements. The recognized sign language movements are converted by AI into the corresponding language and output as voice or text. As a result, even people who do not understand sign language can communicate smoothly with people who use sign language. For example, the sign language conversion system may be equipped with a camera capable of capturing sign language movements in high resolution and detail, accurately capturing fine finger movements and changes in hand position. Next, the sign language conversion system uses AI to analyze the captured video and converts each sign language gesture into the corresponding language. For example, when a sign language gesture expressing “hello” is recognized by AI, it is converted into the language “hello.” Furthermore, the sign language conversion system outputs the converted language as voice or text. In the case of voice output, voice is emitted from a speaker mounted on the glasses; in the case of text output, text is displayed on the display of the glasses. This enables people who do not understand sign language to communicate smoothly with people who use sign language. For example, when a person using sign language places an order at a restaurant, the order details are conveyed as voice or text through the glasses, allowing staff who do not understand sign language to respond smoothly. Thus, the sign language conversion system removes the communication barrier between people who use sign language and those who do not understand it, enabling more people to communicate smoothly. Specifically, the sign language conversion system is equipped with a high-resolution and high-frame-rate (e.g., 1920×1080 pixels, 60 fps or higher) image sensor as the camera unit, capable of simultaneously acquiring RGB images and depth images. The camera unit extracts three-dimensional position information of sign language gestures and fingertip coordinate data (e.g., 21-point landmark vectors, each point having x, y, z coordinates) in real time and transmits these as time-series tensors (e.g., float arrays of frame count×21×3) to the analysis unit. The analysis unit uses convolutional neural networks (CNN), recurrent neural networks (RNN) specialized for time-series processing, or Transformer architectures with self-attention mechanisms to extract features (e.g., motion patterns, speed vectors, shape changes) from the input sign language gesture tensors. The analysis unit inputs these features into a multi-class classifier (e.g., Softmax layer) to obtain outputs such as “sign language word labels” and “gesture start/end timing” for each frame. For example, input examples include “a motion where the right hand rises and the thumb and index finger touch” or “a motion where both hands draw a circle in front of the chest,” and output examples include Japanese labels such as “ [symbol] ” (hello), “ [symbol] ” (thank you), or English labels such as “hello,” “thank you.” The conversion unit inputs the output label sequence from the analysis unit into a context analysis module (e.g., bidirectional LSTM or Transformer Encoder-Decoder), and converts it into natural language sentences (e.g., “Hello, it's a nice day today”) by also considering preceding and following gestures and facial expression information (e.g., smile, surprise). The conversion unit sends the conversion result to a speech synthesis module (e.g., WaveNet or Tacotron2) or a text output module, and in the case of voice, adjusts spectral parameters, pitch, speed, etc., to generate natural speech. The output unit automatically adjusts the tone and volume of voice or the font and size of text according to user preferences and situations (e.g., quiet place, noisy place) to achieve optimal output. As a technical effect, this system, unlike conventional human sign language interpretation or simple rule-based conversion, combines motion recognition, context understanding, and multilingual conversion using deep learning models in high-dimensional feature space to achieve real-time and high-accuracy sign language conversion, greatly reducing communication delays and misrecognition. Furthermore, by dynamically reflecting user emotions and environmental information, more natural and context-adaptive communication support is possible. Specific application fields include support for sign language learning in educational settings, communication with patients in medical institutions, guidance in public facilities and transportation, multilingual sign language interpretation at international conferences, and video conferencing with remote locations. In these fields, the present invention contributes to improving information accessibility and promoting social inclusion.

The sign language conversion system according to the embodiment comprises a camera unit, an analysis unit, a conversion unit, and an output unit. The camera unit captures sign language movements. Sign language movements may include, for example, hand shape, position, speed, direction, and the like, but are not limited thereto. The camera unit can, for example, capture hand movements in detail with high resolution. For example, the camera unit can accurately capture fine finger movements and changes in hand position. The analysis unit uses AI to analyze video captured by the camera unit. The analysis unit can, for example, recognize sign language movements in real time. Real time means, for example, allowing a delay of several milliseconds. The analysis unit converts each sign language gesture into a corresponding language. Each gesture may include, for example, hand shape, position, motion pattern, and the like, but is not limited thereto. The conversion unit uses AI to convert sign language movements recognized by the analysis unit into language. The language may include, for example, Japanese, English, text format, voice format, and the like, but is not limited thereto. The conversion unit improves conversion accuracy by considering the context and meaning of sign language when converting sign language movements into language. For example, the conversion unit uses an algorithm that improves conversion accuracy by considering the context of sign language, and accurately converts sign language movements into language. The output unit outputs the language converted by the conversion unit as voice or text. In the case of voice output, the output unit outputs voice from a speaker mounted on glasses. In the case of text output, the output unit displays text on a display of the glasses. As a result, even people who do not understand sign language can communicate smoothly with people who use sign language. For example, in the case of voice output, the output unit is provided with a function to adjust the tone and speed of voice according to the user's preference. For example, the output unit adjusts the tone of voice according to the user's preference. The output unit can also adjust the speed of voice according to the user's preference. Furthermore, the output unit can simultaneously adjust both the tone and speed of voice according to the user's preference. Thus, the sign language conversion system can convert sign language movements into language in real time and facilitate communication with people who do not understand sign language. Thus, the sign language conversion system according to the embodiment can convert sign language movements into language in real time. Specifically, the sign language conversion system is equipped with a high-resolution and high-frame-rate (e.g., 1920×1080 pixels, 60 fps or higher) image sensor as the camera unit, capable of simultaneously acquiring RGB images and depth images. The camera unit extracts three-dimensional position information of sign language gestures and fingertip coordinate data (e.g., 21-point landmark vectors, each point having x, y, z coordinates) in real time and transmits these as time-series tensors (e.g., float arrays of frame count×21×3) to the analysis unit. The analysis unit uses convolutional neural networks, recurrent neural networks specialized for time-series processing, or Transformer architectures with self-attention mechanisms to extract features (e.g., motion patterns, speed vectors, shape changes) from the input sign language gesture tensors. The analysis unit inputs these features into a multi-class classifier (e.g., Softmax layer) to obtain outputs such as “sign language word labels” and “gesture start/end timing” for each frame. For example, input examples include “a motion where the right hand rises and the thumb and index finger touch” or “a motion where both hands draw a circle in front of the chest,” and output examples include Japanese labels such as “ [symbol] ” (hello), “ [symbol] ” (thank you), or English labels such as “hello,” “thank you.” The conversion unit inputs the output label sequence from the analysis unit into a context analysis module (e.g., bidirectional LSTM or Transformer Encoder-Decoder), and converts it into natural language sentences (e.g., “Hello, it's a nice day today”) by also considering preceding and following gestures and facial expression information (e.g., smile, surprise). The conversion unit sends the conversion result to a speech synthesis module or a text output module, and in the case of voice, adjusts spectral parameters, pitch, speed, etc., to generate natural speech. The output unit automatically adjusts the tone and volume of voice or the font and size of text according to user preferences and situations (e.g., quiet place, noisy place) to achieve optimal output. As a technical effect, this system, unlike conventional human sign language interpretation or simple rule-based conversion, combines motion recognition, context understanding, and multilingual conversion using deep learning models in high-dimensional feature space to achieve real-time and high-accuracy sign language conversion, greatly reducing communication delays and misrecognition. Furthermore, by dynamically reflecting user emotions and environmental information, more natural and context-adaptive communication support is possible. Specific application fields include support for sign language learning in educational settings, communication with patients in medical institutions, guidance in public facilities and transportation, multilingual sign language interpretation at international conferences, and video conferencing with remote locations. In these fields, the present invention contributes to improving information accessibility and promoting social inclusion.

The analysis unit can recognize sign language movements in real time. The analysis unit can, for example, recognize sign language movements in real time. Real time means, for example, allowing a delay of several milliseconds. The analysis unit can use AI to recognize sign language movements in real time. For example, the analysis unit can use an AI model to recognize sign language movements in real time. The AI model learns the features of sign language movements to recognize sign language movements in real time. Thus, the analysis unit can recognize sign language movements in real time. By recognizing sign language movements in real time, immediate conversion to language is possible. Specifically, the analysis unit receives time-series image data and three-dimensional landmark vectors (e.g., float arrays of frame count×21×3) from the camera unit as input. The input data includes RGB images, depth images, finger coordinate data, motion speed vectors, and the like. For example, input examples include “a motion where the right hand rises and the thumb and index finger touch” or “a motion where both hands draw a circle in front of the chest.” The analysis unit uses deep learning models such as convolutional neural networks, recurrent neural networks, and Transformer architectures with self-attention mechanisms to extract features (e.g., motion patterns, speed, shape changes) from these inputs. The analysis unit inputs the extracted features into a multi-class classifier (e.g., Softmax layer) to obtain outputs such as “sign language word labels” and “gesture start/end timing” for each frame. Output examples include Japanese labels such as “ [symbol] [symbol] ” (hello), “ [symbol] ” (thank you), or English labels such as “hello,” “thank you.” The analysis unit sends the output results to the conversion unit, which performs subsequent processing for conversion to natural language sentences or speech synthesis. During model training, the analysis unit uses cross-entropy loss functions and data augmentation techniques (e.g., rotation, scaling, noise addition) to improve accuracy. As a technical effect, the analysis unit, unlike conventional human sign language recognition or simple rule-based processing, performs motion recognition using deep learning models in high-dimensional feature space, enabling real-time and high-accuracy sign language recognition and greatly reducing communication delays and misrecognition. Specific application fields include support for sign language learning in educational settings, communication with patients in medical institutions, guidance in public facilities and transportation, multilingual sign language interpretation at international conferences, and video conferencing with remote locations.

The conversion unit can convert each sign language gesture into a corresponding language. The conversion unit can, for example, convert each sign language gesture into a corresponding language. Each gesture may include, for example, hand shape, position, motion pattern, and the like, but is not limited thereto. The conversion unit can use AI to convert each sign language gesture into a corresponding language. For example, the conversion unit can use an AI model to convert each sign language gesture into a corresponding language. The AI model learns the features of sign language movements to convert sign language movements into language. Thus, the conversion unit can convert each sign language gesture into a corresponding language. This enables accurate conversion of each sign language gesture into language. Specifically, the conversion unit receives as input the sign language word label sequence and gesture timing information from the analysis unit. The input data includes time-series arrays of sign language word labels (e.g., [‘ [symbol] ’, ‘ [symbol] ’]), gesture start/end timing, facial expression information (e.g., smile, surprise), and the like. The conversion unit uses context analysis models such as bidirectional LSTM or Transformer Encoder-Decoder to convert the input into natural language sentences (e.g., “Hello, it's a nice day today”) while considering preceding and following gestures and expression information. Output examples include Japanese sentences such as “ [symbol] [symbol] [symbol] ” or English sentences such as “Hello, it's a nice day today.” The conversion unit sends the conversion result to a speech synthesis module or text output module, and in the case of voice, adjusts spectral parameters, pitch, speed, etc., to generate natural speech. During model training, the conversion unit uses sequence-to-sequence learning, attention mechanisms, and cross-entropy loss functions to improve conversion accuracy. As a technical effect, the conversion unit, unlike conventional rule-based conversion or simple dictionary conversion, combines context understanding and multilingual conversion using deep learning models to convert each sign language gesture into highly accurate and natural language. Specific application fields include support for sign language learning in educational settings, communication with patients in medical institutions, guidance in public facilities and transportation, multilingual sign language interpretation at international conferences, and video conferencing with remote locations.

In the case of voice output, the output unit can output voice from a speaker mounted on glasses. The output unit can, for example, output voice from a speaker mounted on glasses in the case of voice output. The glasses may be equipped with a built-in speaker capable of outputting voice. The output unit is provided with a function to adjust the tone and speed of voice according to the user's preference in the case of voice output. For example, the output unit adjusts the tone of voice according to the user's preference. The output unit can also adjust the speed of voice according to the user's preference. Furthermore, the output unit can simultaneously adjust both the tone and speed of voice according to the user's preference. Thus, in the case of voice output, the output unit can output voice from a speaker mounted on glasses. This enables information to be conveyed to people who do not understand sign language through voice output. Specifically, the output unit receives as input natural language sentences and speech synthesis parameters (e.g., text, spectrum, pitch, speed) from the conversion unit. The output unit uses a speech synthesis module (e.g., WaveNet or Tacotron2) to generate voice waveforms from the input text. The output unit automatically adjusts the tone (e.g., higher, lower), speed (e.g., slow, fast), and volume of voice according to the user's preference and situation (e.g., quiet place, noisy place). For example, for elderly users, the output may be in a slow tone, while for younger users, the output may be in a bright and fast tone. The output unit sends the generated voice waveform to the speaker built into the glasses and plays the voice in real time. As a technical effect, the output unit, unlike conventional fixed voice output or simple text-to-speech, combines natural speech synthesis using deep learning models and user-adaptive parameter adjustment to achieve easy-to-hear and context-appropriate voice output. Specific application fields include support for sign language learning in educational settings, communication with patients in medical institutions, guidance in public facilities and transportation, multilingual sign language interpretation at international conferences, and video conferencing with remote locations.

In the case of text output, the output unit can display text on a display of the glasses. The output unit can, for example, display text on a display of the glasses in the case of text output. The glasses may be equipped with a built-in display capable of displaying text. The output unit is provided with a function to adjust the font and size of text according to the user's visual characteristics in the case of text output. For example, the output unit adjusts the font of text according to the user's visual characteristics. The output unit can also adjust the size of text according to the user's visual characteristics. Furthermore, the output unit can simultaneously adjust both the font and size of text according to the user's visual characteristics. Thus, in the case of text output, the output unit can display text on a display of the glasses. This enables information to be conveyed to people who do not understand sign language through text output. Specifically, the output unit receives as input natural language sentences and text display parameters (e.g., font type, size, color) from the conversion unit. The output unit automatically adjusts the font, size, and contrast of text according to the user's visual characteristics (e.g., color vision characteristics, eyesight, age) and the display specifications of the device (e.g., resolution, screen size). For example, for users with poor eyesight, the output may be displayed in a large font, and high-contrast color schemes may be selected according to color vision characteristics. The output unit displays the adjusted text on the built-in display of the glasses in real time, allowing the user to immediately check the content. As a technical effect, the output unit, unlike conventional fixed text display or simple character output, combines user-adaptive font, size, and contrast adjustment to greatly improve visibility and readability. Specific application fields include support for sign language learning in educational settings, communication with patients in medical institutions, guidance in public facilities and transportation, multilingual sign language interpretation at international conferences, and video conferencing with remote locations.

The camera unit can capture hand movements in detail with high accuracy. The camera unit can, for example, capture hand movements in detail with high accuracy. High accuracy means, for example, high resolution and high frame rate. The camera unit can use AI to capture hand movements in detail. For example, the camera unit can use an AI model to capture hand movements in detail. The AI model learns the features of hand movements to capture hand movements in detail. Thus, the camera unit can capture hand movements in detail with high accuracy. This enables accurate capture of even subtle sign language movements. Specifically, the camera unit is equipped with a high-resolution image sensor of 1920×1080 pixels or higher and a high-frame-rate imaging function of 60 fps or higher, capable of simultaneously acquiring RGB images and depth images. The camera unit extracts 21-point landmark vectors of fingers (each point having x, y, z coordinates) in real time and transmits these as time-series tensors (e.g., float arrays of frame count×21×3) to the analysis unit. The camera unit uses AI models (e.g., object detection CNNs or deep learning models for pose estimation) to automatically extract features such as hand contours, fingertip positions, joint angles, and motion speed from images. Input examples include an open palm, finger bending motion, and hand rotation motion. The camera unit records the extracted features with high accuracy in a time-series manner and transmits them to the analysis unit to improve the accuracy of subsequent sign language recognition processing. As a technical effect, the camera unit, unlike conventional low-resolution cameras or simple image acquisition devices, combines high resolution, high frame rate, and feature extraction using deep learning models to accurately capture even subtle sign language movements and fast motions. Specific application fields include support for sign language learning in educational settings, communication with patients in medical institutions, guidance in public facilities and transportation, multilingual sign language interpretation at international conferences, and video conferencing with remote locations.

The camera unit can estimate a user's emotion and adjust the camera's shooting angle based on the estimated emotion of the user. The camera unit can, for example, estimate a user's emotion and adjust the camera's shooting angle based on the estimated emotion. Emotion estimation may be realized using an emotion engine or generative AI, for example, by using an emotion estimation function. Generative AI may include, for example, text generation AI (e.g., LLM) or multimodal generative AI, but is not limited thereto. For example, when the user is nervous, the camera unit widens the shooting angle to capture sign language movements over a broader area. When the user is relaxed, the camera unit narrows the shooting angle to capture sign language movements in more detail. Furthermore, when the user is in a hurry, the camera unit automatically adjusts the shooting angle to quickly capture sign language movements. Thus, the camera unit can provide the optimal shooting angle according to the user's emotion. Specifically, the camera unit acquires the user's facial images, voice data, and body motion data (e.g., facial expression image tensors, voice waveforms, heart rate time-series data, etc.) from multiple sensors and inputs these as multimodal input tensors (e.g., image frame count×channel count×height×width, voice sample count×feature dimension, vital sign time-series arrays, etc.) into a neural network for emotion estimation. Input examples include “facial images with downturned mouth corners and furrowed brows,” “high-pitched, fast speech,” and “time-series data with higher-than-normal heart rate.” The camera unit uses large language models for emotion estimation or multimodal Transformers to output emotion labels such as “nervous,” “relaxed,” “in a hurry,” and probability distributions (e.g., nervous 0.85, relaxed 0.10, in a hurry 0.05). Output examples include “nervousness score 0.92,” “relaxation score 0.03,” and so on. The camera unit inputs these emotion estimation results into a shooting angle control module to generate control signals for angle adjustment servomotors or electronic zoom. For example, when nervousness is high, the angle is set to wide (e.g., 90 degrees); when relaxation is high, the angle is set to narrow (e.g., 45 degrees); when in a hurry, the angle is set to standard (e.g., 60 degrees). The camera unit also considers the detection area of sign language movements and the position information of the user's face and hands during angle adjustment to achieve optimal framing in real time. As a technical effect, the camera unit, unlike conventional fixed-angle cameras or simple manual adjustment methods, can estimate the user's emotional state with high accuracy and automatically optimize the shooting angle accordingly, greatly improving the recognition accuracy of sign language movements and user experience. In particular, it is possible to accurately capture mistakes during nervousness and subtle expressions during relaxation, reducing misrecognition and information loss in the analysis and conversion units. Specific application fields include support for sign language learning in educational settings, communication with patients in medical institutions, guidance in public facilities and transportation, multilingual sign language interpretation at international conferences, and video conferencing with remote locations, where the user's psychological state may change in various situations and high-accuracy sign language recognition and conversion support is required.

The camera unit can use a plurality of cameras to capture sign language movements in order to capture the speed or direction of hand movements in detail. The camera unit can, for example, use a plurality of cameras to capture the speed or direction of hand movements in detail when capturing sign language movements. The camera unit can use AI to capture the speed or direction of hand movements in detail. For example, the camera unit can use a plurality of cameras to accurately measure the speed of hand movements. The camera unit can also use a plurality of cameras to accurately measure the direction of hand movements. Furthermore, the camera unit can use a plurality of cameras to simultaneously measure both the speed and direction of hand movements. Thus, the camera unit can accurately measure the speed and direction of hand movements. This enables detailed capture of sign language movements. Specifically, the camera unit uses multiple high-resolution cameras placed at different positions and angles (e.g., two stereo cameras on the left and right, three cameras on the top, side, and front) to simultaneously capture sign language movements from multiple viewpoints at the same time. Each camera acquires RGB images and depth images on a frame-by-frame basis and transmits these as time-series tensors (e.g., camera count×frame count×height×width×channel count) to the image processing module within the camera unit. The camera unit uses AI-based object tracking algorithms (e.g., YOLO-based CNNs, deep learning models for pose estimation) to extract finger landmark coordinates (e.g., 21 points×x, y, z) for each frame. The landmark information obtained from multiple cameras is integrated using three-dimensional reconstruction algorithms (e.g., triangulation, multi-view geometry) to calculate three-dimensional trajectory vectors and speed vectors of fingers (e.g., position change per frame/time) with high accuracy. Input examples include “a motion where the right hand rises rapidly” and “a motion where both hands move forward while drawing circles.” Output examples include “speed vector (0.5 m/s, upward direction)” and “direction vector (30 degrees forward).” The camera unit transmits these speed and direction information to the analysis unit, contributing to improved accuracy in semantic analysis and context understanding of sign language movements. As a technical effect, the camera unit, unlike conventional monocular cameras or 2D image analysis methods, combines three-dimensional motion measurement using multiple cameras and high-accuracy feature extraction using AI to accurately capture subtle speed changes and complex movement directions in sign language. This enables reduction of recognition errors, improvement of real-time performance, and separation recognition of simultaneous sign language by multiple people. Specific application fields include support for sign language learning in educational settings, communication with patients in medical institutions, guidance in public facilities and transportation, multilingual sign language interpretation at international conferences, and video conferencing with remote locations, where high-accuracy sign language recognition and conversion support is required for complex sign language movements.

The camera unit can be provided with a filtering function to reduce background noise when capturing sign language movements. The camera unit can, for example, be provided with a filtering function to reduce background noise when capturing sign language movements. Background noise may include, for example, audio noise or video noise, but is not limited thereto. The camera unit can use AI to reduce background noise. For example, the camera unit can use a filtering function to remove background noise. The camera unit can also use a filtering function to remove background motion. Furthermore, the camera unit can use a filtering function to adjust background color. Thus, by removing background noise, the camera unit can capture sign language movements in detail. Specifically, the camera unit inputs captured video frames into a deep learning model for background separation (e.g., U-Net-based segmentation network, background subtraction CNN). The input data includes RGB image tensors (e.g., frame count×height×width×3), and may also include depth images or audio spectra. Input examples include “images with multiple moving people in the background of a person performing sign language” and “videos with colorful backgrounds.” The camera unit uses AI model foreground/background mask estimation results (e.g., per-pixel foreground probability maps) to extract only the sign language movement area and applies blur or monochrome processing to the background area to reduce noise. Output examples include “foreground mask image” and “background-removed sign language movement image.” Furthermore, when background motion is large, the camera unit performs motion vector analysis to separate sign language movements from background movements. For audio noise, the camera unit inputs audio waveforms obtained from microphones into a noise suppression neural network (e.g., Denoising Autoencoder) to generate clear audio signals with reduced environmental sounds and noise components. The camera unit transmits these filtered video and audio data to the analysis unit, contributing to improved sign language recognition accuracy. As a technical effect, the camera unit, unlike conventional simple background removal or noise filters, combines high-accuracy foreground extraction and noise reduction using deep learning models to clearly capture sign language movements even in complex background environments. This enables reduction of misrecognition and false detection, improvement of real-time performance, and enhancement of user experience. Specific application fields include support for sign language learning in educational settings, communication with patients in medical institutions, guidance in public facilities and transportation, multilingual sign language interpretation at international conferences, and video conferencing with remote locations, where high-accuracy sign language recognition and conversion support is required in environments with significant background noise.

The camera unit can estimate a user's emotion and adjust the camera's shooting timing based on the user's emotion. The camera unit can, for example, estimate a user's emotion and adjust the camera's shooting timing based on the user's emotion. Emotion estimation may be realized using an emotion engine or generative AI, for example, by using an emotion estimation function. Generative AI may include, for example, text generation AI (e.g., LLM) or multimodal generative AI, but is not limited thereto. For example, when the user is nervous, the camera unit delays the shooting timing to capture sign language movements in detail. When the user is relaxed, the camera unit advances the shooting timing to quickly capture sign language movements. Furthermore, when the user is in a hurry, the camera unit automatically adjusts the shooting timing to quickly capture sign language movements. Thus, the camera unit can provide the optimal shooting timing according to the user's emotion. Specifically, the camera unit acquires the user's facial images, voice data, and vital signs (e.g., heart rate, skin potential) from multimodal sensors and inputs these into a neural network for emotion estimation (e.g., multimodal Transformer, time-series LSTM). Input examples include “facial expression images during nervousness,” “fast speech waveforms,” and “time-series data with high heart rate.” The camera unit obtains emotion labels such as “nervous,” “relaxed,” “in a hurry,” and probability distributions (e.g., nervous 0.80, relaxed 0.15, in a hurry 0.05) from the AI model. The camera unit inputs the emotion estimation results into a shooting timing control module to automatically adjust frame acquisition intervals and shutter timing. For example, when nervousness is high, the frame rate is lowered (e.g., 30 fps→15 fps) to record each gesture in detail; when relaxation is high, the frame rate is increased (e.g., 30 fps→60 fps) to quickly capture the entire gesture. When in a hurry, the camera unit dynamically optimizes frame acquisition timing according to the user's motion speed and speech content. By adjusting timing in this way, the camera unit records important moments and subtle changes in sign language movements without omission, contributing to improved recognition accuracy in the analysis unit. As a technical effect, the camera unit, unlike conventional fixed frame rate shooting or manual timing adjustment, can estimate the user's emotional state with high accuracy and automatically optimize shooting timing accordingly, enabling accurate capture of important information in sign language movements and reducing misrecognition and information loss. Specific application fields include support for sign language learning in educational settings, communication with patients in medical institutions, guidance in public facilities and transportation, multilingual sign language interpretation at international conferences, and video conferencing with remote locations, where high-accuracy sign language recognition and conversion support is required in situations where the user's psychological state and circumstances change dynamically.

The camera unit can simultaneously capture the user's facial expressions when capturing sign language movements, thereby supplementing the meaning of the sign language. The camera unit can, for example, simultaneously capture the user's facial expressions when capturing sign language movements to supplement the meaning of the sign language. Facial expressions may include, for example, smiles, anger, sadness, and the like, but are not limited thereto. The camera unit can use AI to supplement the meaning of sign language. For example, the camera unit can capture the user's facial expressions simultaneously with sign language movements. The camera unit can also capture the user's mouth movements simultaneously with sign language movements. Furthermore, the camera unit can capture the user's eye movements simultaneously with sign language movements. Thus, the camera unit can simultaneously capture the user's facial expressions to supplement the meaning of sign language. Specifically, the camera unit operates both the sign language gesture camera and the facial expression camera simultaneously to synchronously acquire sign language gesture frames and facial expression frames. The facial expression camera acquires high-resolution images of the entire face or close-up images of facial parts (e.g., mouth, eyes) on a frame-by-frame basis and transmits these as image tensors (e.g., frame count×height×width×channel count) to the facial expression analysis module within the camera unit. The camera unit uses AI-based facial expression recognition models (e.g., ResNet-based CNN, Transformer for expression classification) to output facial expression labels such as “smile,” “anger,” “sadness,” and expression intensity scores (e.g., smile 0.85, anger 0.05) for each frame. Input examples include “facial images with upturned mouth corners” and “facial images with wide-open eyes,” and output examples include “smile label,” “surprise label,” and so on. Furthermore, the camera unit simultaneously detects mouth and eye movements to extract information such as pronunciation shapes and gaze direction. These facial expression, mouth, and eye movement information are synchronized with sign language gesture data in a time-series manner and used for supplementing the meaning of sign language and context understanding in the analysis and conversion units. As a technical effect, the camera unit, unlike conventional sign language gesture-only capture or methods that do not consider facial expressions, can acquire facial expressions, mouth, and eye movements with high accuracy and synchronously, greatly improving the accuracy of emotional expression and meaning interpretation in sign language. This enables accurate recognition of differences in meaning due to facial expressions (e.g., politeness or sarcasm in “thank you”) for the same gesture, realizing natural communication support. Specific application fields include support for sign language learning in educational settings, communication with patients in medical institutions, guidance in public facilities and transportation, multilingual sign language interpretation at international conferences, and video conferencing with remote locations, where emotional expression and nonverbal information are important for high-accuracy sign language recognition and conversion support.

The camera unit can simultaneously acquire environmental information around the user when capturing sign language movements, thereby understanding the context of the sign language. The camera unit can, for example, simultaneously acquire environmental information around the user when capturing sign language movements to understand the context of the sign language. Environmental information may include, for example, surrounding objects, audio, temperature, and the like, but is not limited thereto. The camera unit can use AI to understand the context of sign language. For example, the camera unit can acquire environmental information around the user simultaneously with sign language movements. The camera unit can also acquire audio information around the user simultaneously with sign language movements. Furthermore, the camera unit can acquire light information around the user simultaneously with sign language movements. Thus, the camera unit can simultaneously acquire environmental information around the user to understand the context of sign language. Specifically, the camera unit is equipped with additional sensors for understanding the surrounding environment (e.g., omnidirectional camera, environmental microphone, temperature/humidity sensor, illuminance sensor) in addition to the high-resolution image sensor for capturing sign language movements. The camera unit simultaneously acquires data from these sensors as time-series tensors (e.g., frame count×channel count×height×width image tensors, audio waveform arrays, time-series vectors of temperature, humidity, illuminance) and inputs them into the environmental information extraction module. Input examples include “images with chairs and desks behind the person performing sign language,” “audio waveforms with conversation or noise occurring nearby,” and “environmental data of room temperature 25° C., humidity 60%, illuminance 300 lx.” The camera unit uses AI-based object detection models (e.g., YOLO-based CNN), audio event detection models (e.g., CNN for acoustic classification), and environmental feature extraction algorithms to extract object labels (e.g., chair, desk, whiteboard) from images, event labels (e.g., conversation, applause, noise) from audio, and environmental states (e.g., bright, quiet, hot) from sensor values. Output examples include “object label: chair, desk,” “audio event: conversation,” “environmental state: bright,” and so on. The camera unit synchronizes these environmental information with sign language gesture data in a time-series manner and transmits them to the analysis unit. The analysis unit inputs the received environmental information into a sign language context understanding module (e.g., multimodal Transformer) and utilizes it for meaning interpretation and context estimation of sign language movements. For example, context estimation according to the environment, such as “sign language in a classroom,” “sign language during a meeting,” or “sign language outdoors,” becomes possible. As a technical effect, the camera unit, unlike conventional sign language gesture-only capture methods, can acquire and analyze environmental information with high accuracy and in real time, enabling improved meaning interpretation, reduced misrecognition, and context-adaptive language conversion accuracy. In particular, when the meaning of the same gesture changes depending on the environment (e.g., the meaning of “sit” gesture differs depending on the presence of a chair), AI can take environmental information into account to perform optimal recognition and conversion. Specific application fields include support for sign language learning in educational settings (automatic recognition of classroom environment), communication with patients in medical institutions (understanding of hospital room/consultation room environment), guidance in public facilities and transportation (recognition of station/airport/bus stop environment), multilingual sign language interpretation at international conferences (environmental adaptation in conference rooms/auditoriums), and video conferencing with remote locations (adaptation to changes in home/office/outdoor environments), where the present invention demonstrates technical effects of greatly improving context adaptability and information accessibility in sign language recognition and conversion.

The analysis unit can estimate a user's emotion and adjust the analysis accuracy of sign language movements based on the user's emotion. The analysis unit can, for example, estimate a user's emotion and adjust the analysis accuracy of sign language movements based on the user's emotion. Emotion estimation may be realized using an emotion engine or generative AI, for example, by using an emotion estimation function. Generative AI may include, for example, text generation AI (e.g., LLM) or multimodal generative AI, but is not limited thereto. For example, when the user is nervous, the analysis unit increases the analysis accuracy to analyze sign language movements in detail. When the user is relaxed, the analysis unit decreases the analysis accuracy to analyze sign language movements quickly. Furthermore, when the user is in a hurry, the analysis unit automatically adjusts the analysis accuracy to analyze sign language movements quickly. Thus, the analysis unit can adjust the analysis accuracy according to the user's emotion. Specifically, the analysis unit inputs multimodal data such as the user's facial images, voice data, and vital signs (e.g., heart rate, skin potential) received from the camera unit into a neural network for emotion estimation (e.g., multimodal Transformer, time-series LSTM) to output emotion labels (e.g., “nervous,” “relaxed,” “in a hurry”) and probability distributions (e.g., nervous 0.80, relaxed 0.15, in a hurry 0.05). Input examples include “facial expression images during nervousness,” “fast speech waveforms,” and “time-series data with high heart rate.” The analysis unit dynamically adjusts the parameters of the sign language gesture analysis module (e.g., convolutional layer kernel size, time-series window width, feature extraction threshold, dropout rate during inference) based on the emotion estimation results. For example, when nervousness is high, the analysis unit reduces the kernel size of the convolutional layer and widens the time-series window to extract more detailed features and reduce misrecognition. When relaxation is high, the analysis unit relaxes the feature extraction threshold and switches to parameter settings that prioritize inference speed. When in a hurry, the analysis unit increases the dropout rate during inference to speed up processing, automatically optimizing the balance between analysis accuracy and speed. The analysis unit reflects these parameter adjustment results in the sign language gesture recognition model (e.g., CNN, RNN, Transformer) to control analysis accuracy in real time. Output examples include “sign language word label in high-accuracy mode” and “gesture timing estimation in high-speed mode.” The analysis unit transmits the adjusted analysis results to the conversion unit, contributing to improved accuracy in subsequent language conversion and speech synthesis processing. As a technical effect, the analysis unit, unlike conventional fixed-parameter methods or manual adjustment by human operators, can estimate the user's emotional state with high accuracy using AI and automatically optimize analysis accuracy accordingly, enabling reduction of sign language recognition errors, improvement of real-time performance, and individual optimization of user experience. Specific application fields include support for sign language learning in educational settings (accuracy-prioritized mode for students prone to nervousness), communication with patients in medical institutions (analysis speed adjustment according to situation), guidance in public facilities and transportation (high-speed analysis during crowded times), multilingual sign language interpretation at international conferences (optimization according to presenter's psychological state), and video conferencing with remote locations (dynamic response to changing situations), where the present invention demonstrates technical effects of greatly improving the accuracy, speed, and adaptability of sign language recognition and conversion.

The analysis unit can use an algorithm for detailed analysis of changes in hand shape and position when analyzing sign language movements. The analysis unit can, for example, use an algorithm for detailed analysis of changes in hand shape and position when analyzing sign language movements. Algorithms may include, for example, machine learning algorithms or image processing algorithms, but are not limited thereto. The analysis unit can use AI to analyze changes in hand shape and position in detail. For example, the analysis unit uses an algorithm for detailed analysis of changes in hand shape to accurately analyze sign language movements. The analysis unit can also use an algorithm for detailed analysis of changes in hand position to accurately analyze sign language movements. Furthermore, the analysis unit can use an algorithm for simultaneous analysis of changes in hand shape and position to accurately analyze sign language movements. Thus, the analysis unit can analyze changes in hand shape and position in detail. Specifically, the analysis unit receives high-resolution RGB images, depth images, and three-dimensional landmark vectors of fingers (e.g., float arrays of frame count×21×3) from the camera unit as input data. The input data includes image tensors for hand contour extraction, coordinate sequences of fingertips and joints, palm normal vectors, hand motion speed vectors, and the like. Input examples include “a motion where the fingers are bent sequentially from an open palm” and “a motion where the hand rotates while moving forward.” The analysis unit uses deep learning models such as convolutional neural networks (CNN), graph neural networks (GNN), and Transformer architectures with self-attention mechanisms to extract hand shape features (e.g., finger bending angles, palm opening/closing degree, inter-finger distances) and position features (e.g., spatial coordinates, movement vectors, relative positional relationships) in high-dimensional feature space from images and coordinate sequences. The analysis unit integrates the extracted features in a time-series manner and inputs them into a motion pattern recognition module (e.g., time-series LSTM, Temporal CNN) to output sign language word labels, gesture start/end timing, and feature scores for each gesture segment. Output examples include “sign language word label: thank you,” “gesture segment: frames 10-25,” and “shape change score: 0.92.” The analysis unit transmits these outputs to the conversion unit for use in subsequent natural language conversion and speech synthesis processing. During model training, the analysis unit uses data augmentation techniques (e.g., rotation, scaling, noise addition), cross-entropy loss functions, and weight optimization algorithms (e.g., Adam, SGD) to improve accuracy. The analysis unit, unlike conventional manual work or simple rule-based processing, combines feature extraction, time-series integration, and multi-stage classification in high-dimensional space to analyze subtle shape changes and complex position changes in sign language movements in real time and with high accuracy. As a technical effect, the analysis unit enables reduction of sign language recognition errors, improvement of real-time performance, and enhanced capability to handle simultaneous sign language by multiple people and fast movements. Specific application fields include support for sign language learning in educational settings (motion feedback by instructors), communication with patients in medical institutions (detection of subtle finger movements), guidance in public facilities and transportation (automatic recognition of complex sign language movements), multilingual sign language interpretation at international conferences (high-accuracy analysis of diverse sign language expressions), and video conferencing with remote locations (motion correction under communication delays), where the present invention demonstrates technical effects of greatly improving the accuracy, speed, and adaptability of sign language recognition and conversion.

The analysis unit can improve analysis accuracy by considering the grammar and structure of sign language when analyzing sign language movements. The analysis unit can, for example, improve analysis accuracy by considering the grammar and structure of sign language when analyzing sign language movements. Grammar and structure of sign language may include, for example, sentence composition, verb position, and the like, but are not limited thereto. The analysis unit can use AI to consider the grammar and structure of sign language. For example, the analysis unit uses an algorithm that improves analysis accuracy by considering the grammar of sign language to accurately analyze sign language movements. The analysis unit can also use an algorithm that improves analysis accuracy by considering the structure of sign language to accurately analyze sign language movements. Furthermore, the analysis unit can use an algorithm that simultaneously considers the grammar and structure of sign language to improve analysis accuracy and accurately analyze sign language movements. Thus, the analysis unit can improve analysis accuracy by considering the grammar and structure of sign language. Specifically, the analysis unit receives time-series label sequences of sign language gestures, gesture segment information, facial expression and environmental information from the camera unit as input data. The input data includes time-series arrays of sign language word labels (e.g., [‘I’, ‘go’, ‘school’]), gesture start/end timing, facial expression scores, environmental labels, and the like. Input examples include “sign language performed in the order of subject→verb→object” and “sign language with the verb placed at the end of the sentence.” The analysis unit uses a sign language grammar analysis module (e.g., bidirectional LSTM, Transformer Encoder-Decoder, syntax tree generation algorithm) to extract grammatical structure (e.g., relationships among subject, predicate, object; position of modifiers; expression of tense, negation, question) and sign language-specific structures (e.g., spatial reference, integration of non-manual elements) from the input sequence. The analysis unit applies an algorithm for automatic correction of misrecognition and grammatical errors (e.g., syntax scoring, grammar error correction network) based on the extracted grammar and structure information to evaluate semantic consistency and contextual relevance of the sign language gesture sequence. Output examples include “grammatical structure label: subject-verb-object,” “syntax consistency score: 0.95,” and “corrected label sequence: [‘I’, ‘school’, ‘go’].” The analysis unit transmits these outputs to the conversion unit, contributing to improved accuracy in conversion to natural language sentences and speech synthesis processing. During model training, the analysis unit uses sign language grammar corpora and syntax annotation data, combining cross-entropy loss functions and syntax consistency loss to improve learning accuracy. The analysis unit, unlike conventional simple word sequence recognition or manual grammar correction by human operators, combines grammar and structure analysis in high-dimensional feature space with automatic correction algorithms to greatly reduce grammatical and structural misrecognition in sign language and realize natural context understanding. As a technical effect, the analysis unit enables reduction of grammatical errors in sign language recognition, improvement of context adaptability, and enhanced capability to handle complex sentence structures. Specific application fields include support for sign language learning in educational settings (grammar instruction and correction), communication with patients in medical institutions (accurate context transmission), guidance in public facilities and transportation (automatic analysis of complex instruction sentences), multilingual sign language interpretation at international conferences (adaptation to grammar of sign languages of various countries), and video conferencing with remote locations (prevention of context misunderstanding), where the present invention demonstrates technical effects of greatly improving grammatical accuracy and context adaptability in sign language recognition and conversion.

The analysis unit can estimate a user's emotion and adjust the analysis speed of sign language movements based on the user's emotion. The analysis unit can, for example, estimate a user's emotion and adjust the analysis speed of sign language movements based on the user's emotion. Emotion estimation may be realized using an emotion engine or generative AI, for example, by using an emotion estimation function. Generative AI may include, for example, text generation AI (e.g., LLM) or multimodal generative AI, but is not limited thereto. For example, when the user is nervous, the analysis unit slows down the analysis speed to analyze sign language movements in detail. When the user is relaxed, the analysis unit speeds up the analysis to quickly analyze sign language movements. Furthermore, when the user is in a hurry, the analysis unit automatically adjusts the analysis speed to quickly analyze sign language movements. Thus, the analysis unit can adjust the analysis speed according to the user's emotion. Specifically, the analysis unit inputs multimodal data such as the user's facial images, voice data, and vital signs (e.g., heart rate, skin potential) received from the camera unit into a neural network for emotion estimation (e.g., multimodal Transformer, time-series LSTM) to output emotion labels (e.g., “nervous,” “relaxed,” “in a hurry”) and probability distributions (e.g., nervous 0.80, relaxed 0.15, in a hurry 0.05). Input examples include “facial expression images during nervousness,” “fast speech waveforms,” and “time-series data with high heart rate.” The analysis unit dynamically adjusts inference speed parameters of the sign language gesture analysis module (e.g., batch size, inference thread count, model lightweight settings, dropout rate) based on the emotion estimation results. For example, when nervousness is high, the analysis unit reduces batch size and inference thread count to perform sequential processing, prioritizing detailed feature extraction and reduction of misrecognition. When relaxation is high, the analysis unit increases batch size and inference thread count to perform parallel processing, prioritizing analysis speed. When in a hurry, the analysis unit speeds up processing by applying model lightweight settings and increasing dropout rate, automatically optimizing the balance between analysis speed and accuracy. The analysis unit reflects these parameter adjustment results in the sign language gesture recognition model (e.g., CNN, RNN, Transformer) to control analysis speed in real time. Output examples include “sign language word label in detailed analysis mode” and “gesture timing estimation in high-speed mode.” The analysis unit transmits the adjusted analysis results to the conversion unit, contributing to improved real-time performance in subsequent language conversion and speech synthesis processing. As a technical effect, the analysis unit, unlike conventional fixed-speed methods or manual adjustment by human operators, can estimate the user's emotional state with high accuracy using AI and automatically optimize analysis speed accordingly, enabling improved real-time performance, individual optimization of user experience, and reduction of misrecognition in sign language recognition. Specific application fields include support for sign language learning in educational settings (detailed analysis for students prone to nervousness), communication with patients in medical institutions (analysis speed adjustment according to situation), guidance in public facilities and transportation (high-speed analysis during crowded times), multilingual sign language interpretation at international conferences (optimization according to presenter's psychological state), and video conferencing with remote locations (dynamic response to changing situations), where the present invention demonstrates technical effects of greatly improving the speed, adaptability, and accuracy of sign language recognition and conversion.

The analysis unit can simultaneously analyze the user's facial expressions and mouth movements when analyzing sign language movements, thereby supplementing the meaning of the sign language. The analysis unit can, for example, simultaneously analyze the user's facial expressions and mouth movements when analyzing sign language movements to supplement the meaning of the sign language. Facial expressions may include, for example, smiles, anger, sadness, and the like, but are not limited thereto. Mouth movements may include, for example, pronunciation shapes or mouth opening/closing, but are not limited thereto. The analysis unit can use AI to supplement the meaning of sign language. For example, the analysis unit can analyze the user's facial expressions simultaneously with sign language movements. The analysis unit can also analyze the user's mouth movements simultaneously with sign language movements. Furthermore, the analysis unit can analyze the user's eye movements simultaneously with sign language movements. Thus, the analysis unit can simultaneously analyze the user's facial expressions and mouth movements to supplement the meaning of sign language. Specifically, the analysis unit receives sign language gesture frames, facial expression image tensors (e.g., frame count×height×width×channel count), close-up images of the mouth, and images of the eyes from the camera unit as input data. The input data includes facial expression features of the entire face, mouth opening/closing and shape parameters, eye opening/closing and gaze direction vectors, and the like. Input examples include “smiling facial image with upturned mouth corners,” “pronunciation shape image with mouth wide open,” and “surprised facial image with wide-open eyes.” The analysis unit uses facial expression recognition models (e.g., ResNet-based CNN, Transformer for expression classification), mouth shape recognition models (e.g., CNN for mouth region), and eye movement recognition models (e.g., deep learning model for gaze estimation) to output facial expression labels such as “smile,” “anger,” “sadness” and intensity scores (e.g., smile 0.85, anger 0.05), “pronunciation shape label,” “mouth opening/closing score,” “gaze direction vector” for each frame. The analysis unit synchronizes these facial expression, mouth, and eye movement information with sign language gesture data in a time-series manner and inputs them into a sign language meaning supplement module (e.g., multimodal Transformer). The analysis unit extracts integrated features of sign language gestures and non-manual elements (facial expressions, mouth, eyes) to improve context understanding and meaning interpretation accuracy. Output examples include “sign language word label: thank you (polite),” “expression correction score: 0.92,” and “pronunciation shape label: /a/.” The analysis unit transmits these outputs to the conversion unit, contributing to improved accuracy in conversion to natural language sentences and speech synthesis processing. During model training, the analysis unit uses datasets annotated with facial expressions, mouth shapes, and eye movements, applying cross-entropy loss functions and multitask learning to improve accuracy. The analysis unit, unlike conventional sign language gesture-only analysis or manual supplement of expressions by human operators, realizes high-accuracy integrated analysis of non-manual elements using multimodal AI, greatly improving the accuracy of emotional expression and meaning interpretation in sign language. As a technical effect, the analysis unit enables accurate recognition of differences in meaning due to facial expressions and mouth shapes (e.g., politeness or sarcasm in “thank you”) for the same gesture, realizing natural communication support. Specific application fields include support for sign language learning in educational settings (instruction in emotional expression), communication with patients in medical institutions (accurate transmission of emotion and intent), guidance in public facilities and transportation (automatic analysis of nonverbal information), multilingual sign language interpretation at international conferences (transmission of emotional nuances), and video conferencing with remote locations (supplementation of expressions and mouth shapes), where the present invention demonstrates technical effects of greatly improving the accuracy of meaning interpretation and emotional adaptability in sign language recognition and conversion.

The analysis unit can refer to the user's past sign language history to improve analysis accuracy when analyzing sign language movements. The analysis unit can, for example, refer to the user's past sign language history to improve analysis accuracy when analyzing sign language movements. Sign language history may include, for example, past sign language data or methods of storing history, but is not limited thereto. The analysis unit can use AI to improve analysis accuracy. For example, the analysis unit can refer to the user's past sign language history to improve analysis accuracy. The analysis unit can also analyze the user's past sign language history to accurately analyze sign language movements. Furthermore, the analysis unit can quickly analyze sign language movements based on the user's past sign language history. Thus, the analysis unit can improve analysis accuracy by referring to the user's past sign language history. Specifically, the analysis unit refers to a sign language gesture database recorded for each user in a time-series manner (e.g., structured database including sign language gesture frames for the past month, sign language word label sequences, gesture start/end timing, facial expression scores, environmental information, etc.). The input data includes current sign language gesture tensors (e.g., float arrays of frame count×21×3), facial expression images, voice data received from the camera unit. The analysis unit compares these current input data with past history data and uses a similarity calculation module (e.g., cosine similarity, dynamic time warping (DTW), feature space distance calculation) to identify frequently occurring gesture patterns and expression patterns in the past. For example, if the input is “a motion where the right hand is raised and the thumb and index finger touch,” and similar gestures are recorded multiple times in the past history, the analysis unit refers to that history to increase the recognition confidence of the “hello” label. The analysis unit learns user-specific gesture habits and expression tendencies (e.g., hand angle habits, individual differences in motion speed, emphasis of expressions) using AI models (e.g., user-adaptive Transformer, personalized RNN) and applies personalized weights and biases during inference. Output examples include “sign language word label: thank you (user history reference confidence 0.95),” “gesture segment: frames 10-25,” and “history match score: 0.92.” The analysis unit transmits recognition results based on history reference to the conversion unit, contributing to improved accuracy in subsequent natural language conversion and speech synthesis processing. During model training, the analysis unit adds user-specific history data as training data (fine-tuning), combining cross-entropy loss functions and history match loss for optimization. As a technical effect, the analysis unit, unlike conventional generic models or non-history reference methods, can utilize user-specific history with high accuracy, greatly reducing misrecognition due to individual differences and realizing individual optimization of analysis accuracy, speed, and user experience. Specific application fields include individualized support for sign language learning in educational settings (recognition according to each student's progress and habits), communication with patients in medical institutions (adaptation to patient-specific gesture patterns), support for regular users in public facilities and transportation (improved recognition accuracy based on usage history), multilingual sign language interpretation at international conferences (optimization according to presenter's expression tendencies), and video conferencing with remote locations (reduction of misrecognition by referring to history), where the present invention demonstrates technical effects of individual optimization, improved accuracy, and enhanced real-time performance in sign language recognition and conversion.

The conversion unit can estimate the user's emotion and adjust the method of expression when converting sign language movements into language based on the user's emotion. For example, the conversion unit estimates the user's emotion and adjusts the method of expression when converting sign language movements into language based on the user's emotion. Emotion estimation is realized, for example, by using an emotion estimation function with an emotion engine or generative AI. Generative AI may be, for example, a text generation AI (such as LLM) or a multimodal generative AI, but is not limited to these examples. For instance, when the user is nervous, the conversion unit uses a simple method of expression to convert sign language movements into language. When the user is relaxed, the conversion unit can use a detailed method of expression to convert sign language movements into language. Furthermore, when the user is in a hurry, the conversion unit can use a rapid method of expression to convert sign language movements into language. Thus, the conversion unit can provide the optimal method of expression according to the user's emotion. Specifically, the conversion unit receives sign language gesture data (e.g., sign language word label sequences, gesture timing, facial expression scores, speech speed information, etc.) from the camera unit and analysis unit, and emotion labels (e.g., “nervous”, “relaxed”, “in a hurry”) or probability distributions (e.g., nervous 0.80, relaxed 0.15, in a hurry 0.05) output from an emotion estimation neural network (e.g., multimodal Transformer, time-series LSTM) as input. Examples of input include “facial expression images when nervous”, “fast speech waveforms”, “time-series data of high heart rate”, etc. The conversion unit dynamically adjusts generation parameters (e.g., level of detail of output sentences, sentence length, vocabulary selection, expression style) in a natural language generation module (e.g., Transformer Encoder-Decoder, conditional LSTM) according to the emotion label. For example, when the nervousness is high, the conversion unit prioritizes short and concise expressions (e.g., “Yes”, “No”), and when the relaxation is high, generates detailed explanations and polite expressions (e.g., “Good morning. Thank you for your cooperation today”). When in a hurry, it selects expressions that quickly convey only the main points (e.g., “Departing”, “Arrived”). Examples of output include “Simple expression: Thank you”, “Detailed expression: Thank you for your cooperation today”, “Rapid expression: Understood”, etc. The conversion unit sends these expression adjustment results to a speech synthesis module or text output module to realize language output optimized for the user's emotional state. During model training, the conversion unit uses emotion-labeled corpora and expression style annotation data, combining cross-entropy loss functions and style control loss to improve learning accuracy. As a technical effect, unlike conventional fixed expression methods or manual expression adjustment by human operators, the conversion unit combines AI-based emotion estimation and dynamic expression control to generate optimal language expressions in real time according to the user's psychological state and situation. Specific application fields include sign language learning support in educational settings (expression adjustment according to students' nervousness), communication with patients in medical institutions (explanatory expressions according to patients' psychological state), guidance in public facilities and transportation (guidance expressions according to users' situations), multilingual sign language interpretation at international conferences (expression optimization according to presenters' emotions), and video conferences with remote locations (dynamic response to changing situations). In these fields, the present invention exhibits technical effects such as adaptability of sign language verbalization, improvement of user experience, and communication efficiency.

The conversion unit can improve conversion accuracy by considering the context and meaning of sign language when converting sign language movements into language. For example, the conversion unit improves conversion accuracy by considering the context and meaning of sign language when converting sign language movements into language. The context and meaning of sign language may include, for example, preceding and following context and interpretation of meaning, but are not limited to these examples. The conversion unit can use AI to consider the context and meaning of sign language. For example, the conversion unit uses an algorithm that improves conversion accuracy by considering the context of sign language, thereby accurately converting sign language movements into language. The conversion unit can also use an algorithm that improves conversion accuracy by considering the meaning of sign language, thereby accurately converting sign language movements into language. Furthermore, the conversion unit can use an algorithm that simultaneously considers both the context and meaning of sign language to improve conversion accuracy, thereby accurately converting sign language movements into language. Thus, by considering the context and meaning of sign language, the conversion unit can improve conversion accuracy. Specifically, the conversion unit receives time-series data such as sign language word label sequences, gesture start/end timing, facial expression scores, and environmental information from the analysis unit as input. Input data includes arrays of sign language word labels (e.g., [‘I’, ‘go’, ‘school’]), gesture segment information, expression labels, environmental labels, etc. Examples of input include “sign language performed in the order of subject→verb→object”, “sign language with the verb placed at the end of the sentence”, “sign language with emphasized facial expressions”, etc. The conversion unit uses a context analysis module (e.g., bidirectional LSTM, Transformer Encoder-Decoder, conditional generation model) to integrate preceding and following gestures, facial expressions, and environmental information, and evaluates contextual consistency and semantic relevance. Based on context and meaning information, the conversion unit dynamically adjusts natural language generation parameters (e.g., word order, tense, negation/interrogative expressions, insertion of modifiers, vocabulary selection) to generate optimal natural language sentences. Examples of output include “Japanese sentence: Watashi wa gakkou ni ikimasu”, “English sentence: I go to school”, “Context-corrected sentence: Kyou wa gakkou ni ikimasen” (Today I do not go to school), etc. The conversion unit sends these context and meaning consideration results to a speech synthesis module or text output module to realize natural language output. During model training, the conversion unit uses sign language context corpora and meaning annotation data, combining cross-entropy loss functions and context consistency loss to improve learning accuracy. As a technical effect, unlike conventional simple word sequence conversion or manual context correction by human operators, the conversion unit combines AI-based high-dimensional context and semantic analysis with dynamic generation control, thereby greatly reducing contextual and semantic conversion errors in sign language and enabling natural communication. Specific application fields include sign language learning support in educational settings (teaching context understanding), communication with patients in medical institutions (accurate meaning transmission), guidance in public facilities and transportation (automatic generation of complex instruction sentences), multilingual sign language interpretation at international conferences (adaptation to the context of each country's sign language), and video conferences with remote locations (prevention of context misunderstanding). In these fields, the present invention exhibits technical effects such as improved context adaptability, semantic interpretation accuracy, and natural language generation capability in sign language verbalization.

The conversion unit can add a multilingual conversion function to support multiple languages when converting sign language movements into language. For example, the conversion unit adds a multilingual conversion function to support multiple languages when converting sign language movements into language. The multilingual conversion function may include, for example, types of supported languages and conversion algorithms, but is not limited to these examples. The conversion unit can use AI to convert sign language movements into multiple languages. For example, the conversion unit adds a function to convert sign language movements into English and converts sign language movements into English. The conversion unit can also add a function to convert sign language movements into Spanish and convert sign language movements into Spanish. Furthermore, the conversion unit can add a function to convert sign language movements into French and convert sign language movements into French. Thus, by supporting multiple languages, the conversion unit can convert sign language movements into multiple languages. Specifically, the conversion unit receives time-series data such as sign language word label sequences, context information, and facial expression scores from the analysis unit as input. Input data includes arrays of sign language word labels (e.g., [‘Thank you’, ‘Hello’]), gesture segment information, expression labels, environmental labels, etc. The conversion unit uses a multilingual neural machine translation model (e.g., multilingual Transformer Encoder-Decoder, conditional generation model) to simultaneously convert the input sign language gesture sequence into multiple target languages (e.g., Japanese, English, Spanish, French, German, Chinese, etc.). For each language, the conversion unit generates natural language sentences considering word order, grammar, expression style, and cultural nuances. For example, if the input is the sign language gesture “Thank you”, the output examples are “Japanese: [symbol] ”, “English: Thank you”, “Spanish: Gracias”, “French: Merci”, etc. The conversion unit can automatically select the output language or output multiple languages simultaneously according to user settings and usage environment. During model training, the conversion unit uses multilingual corpora and alignment data for each language pair, combining cross-entropy loss functions and multilingual consistency loss to improve learning accuracy. As a technical effect, unlike conventional single-language conversion or manual translation by human operators, the conversion unit combines AI-based simultaneous multilingual conversion and dynamic language selection, greatly improving global communication support and adaptability to multicultural environments. Specific application fields include multilingual sign language learning support in educational settings, communication with multinational patients in medical institutions, multilingual guidance in public facilities and transportation, multilingual sign language interpretation at international conferences, and multilingual video conferences with remote locations. In these fields, the present invention exhibits technical effects such as improved multilingual adaptability, translation accuracy, and international accessibility in sign language verbalization.

The conversion unit can estimate the user's emotion and adjust the speed of conversion when converting sign language movements into language based on the user's emotion. For example, the conversion unit estimates the user's emotion and adjusts the speed of conversion when converting sign language movements into language based on the user's emotion. Emotion estimation is realized, for example, by using an emotion estimation function with an emotion engine or generative AI. Generative AI may be, for example, a text generation AI (such as LLM) or a multimodal generative AI, but is not limited to these examples. For instance, when the user is nervous, the conversion unit slows down the conversion speed to convert sign language movements into language in detail. When the user is relaxed, the conversion unit can speed up the conversion to quickly convert sign language movements into language. Furthermore, when the user is in a hurry, the conversion unit can automatically adjust the conversion speed to quickly convert sign language movements into language. Thus, the conversion unit can provide the optimal conversion speed according to the user's emotion. Specifically, the conversion unit receives sign language gesture data (e.g., sign language word label sequences, gesture timing, facial expression scores, speech speed information, etc.) from the camera unit and analysis unit, and emotion labels (e.g., “nervous”, “relaxed”, “in a hurry”) or probability distributions (e.g., nervous 0.80, relaxed 0.15, in a hurry 0.05) output from an emotion estimation neural network (e.g., multimodal Transformer, time-series LSTM) as input. Examples of input include “facial expression images when nervous”, “fast speech waveforms”, “time-series data of high heart rate”, etc. The conversion unit dynamically adjusts inference speed parameters (e.g., batch size, number of inference threads, model lightweight settings, dropout rate, etc.) in a natural language generation module (e.g., Transformer Encoder-Decoder, conditional LSTM) according to the emotion label. For example, when the nervousness is high, the conversion unit reduces the batch size and prioritizes sequential processing for detailed conversion; when the relaxation is high, it increases the batch size and parallel processing for high-speed conversion. When in a hurry, it maximizes conversion speed by setting the model to lightweight and increasing the dropout rate. Examples of output include “Japanese sentence in detailed conversion mode”, “English sentence in high-speed conversion mode”, etc. The conversion unit sends these speed adjustment results to a speech synthesis module or text output module to realize language output optimized for the user's emotional state. During model training, the conversion unit uses emotion-labeled corpora and speed control annotation data, combining cross-entropy loss functions and speed control loss to improve learning accuracy. As a technical effect, unlike conventional fixed-speed methods or manual speed adjustment by human operators, the conversion unit combines AI-based emotion estimation and dynamic speed control to realize optimal conversion speed in real time according to the user's psychological state and situation. Specific application fields include sign language learning support in educational settings (conversion speed adjustment according to students' nervousness), communication with patients in medical institutions (conversion speed optimization according to patients' psychological state), guidance in public facilities and transportation (guidance speed adjustment according to users' situations), multilingual sign language interpretation at international conferences (speed optimization according to presenters' emotions), and video conferences with remote locations (dynamic response to changing situations). In these fields, the present invention exhibits technical effects such as adaptability of conversion speed, improvement of user experience, and enhancement of real-time performance in sign language verbalization.

The conversion unit can improve conversion accuracy by referring to the user's past sign language history when converting sign language movements into language. For example, the conversion unit improves conversion accuracy by referring to the user's past sign language history when converting sign language movements into language. Sign language history may include, for example, past sign language data and methods of storing history, but is not limited to these examples. The conversion unit can use AI to improve conversion accuracy of sign language. For example, the conversion unit refers to the user's past sign language history to improve conversion accuracy. The conversion unit can also analyze the user's past sign language history to accurately convert sign language movements into language. Furthermore, the conversion unit can quickly convert sign language movements into language based on the user's past sign language history. Thus, by referring to the user's past sign language history, the conversion unit can improve conversion accuracy. Specifically, the conversion unit refers to a database of past sign language gesture data recorded for each user (e.g., a structured database containing sign language word label sequences for the past month, gesture segment information, facial expression scores, conversion result sentences, etc.). Input data includes current sign language word label sequences, gesture timing, and expression information received from the analysis unit. The conversion unit compares current input data with past history data, uses a similarity calculation module (e.g., cosine similarity, dynamic time warping (DTW), feature space distance calculation) to identify frequently occurring conversion patterns and expression tendencies in the past. For example, if the input is the sign language gesture “Thank you” and there are multiple records in the past history where “Thank you” was converted to “Thank you”, the conversion unit refers to that history to increase conversion confidence. The conversion unit learns user-specific expression tendencies and vocabulary selection (e.g., frequent use of polite language, preference for abbreviated expressions) with an AI model (e.g., user-adaptive Transformer, personalized LSTM), and applies personalized weights and biases during inference. Examples of output include “Japanese sentence: Arigatou gozaimasu (history reference confidence 0.95)”, “English sentence: Thank you very much (history match score 0.92)”, etc. The conversion unit sends conversion results based on history reference to a speech synthesis module or text output module to realize language output optimized for the user's expression tendencies. During model training, the conversion unit adds user-specific history data as training data (fine-tuning), combining cross-entropy loss functions and history match loss for optimization. As a technical effect, unlike conventional generic models or non-history reference methods, the conversion unit utilizes individual user history with high accuracy, greatly reducing conversion errors due to individual differences and realizing individual optimization of conversion accuracy, speed, and user experience. Specific application fields include individualized sign language learning support in educational settings (conversion according to each student's progress and habits), communication with patients in medical institutions (adaptation to patients' unique expression tendencies), support for regular users in public facilities and transportation (improved conversion accuracy based on usage history), multilingual sign language interpretation at international conferences (optimization according to presenters' expression tendencies), and video conferences with remote locations (reduction of conversion errors by history reference). In these fields, the present invention exhibits technical effects such as individual optimization, improved accuracy, and enhanced real-time performance in sign language verbalization.

The conversion unit can use language expressions corresponding to the user's region or culture when converting sign language movements into language. For example, the conversion unit uses language expressions corresponding to the user's region or culture when converting sign language movements into language. Region and culture may include, for example, region-specific sign language and cultural background, but are not limited to these examples. The conversion unit can use AI to adjust sign language expressions. For example, the conversion unit uses language expressions corresponding to the user's region to convert sign language movements into language. The conversion unit can also use language expressions corresponding to the user's culture to convert sign language movements into language. Furthermore, the conversion unit can simultaneously use language expressions corresponding to both the user's region and culture to convert sign language movements into language. Thus, by using language expressions corresponding to the user's region or culture, the conversion unit can provide more appropriate language conversion. Specifically, the conversion unit receives time-series data such as sign language word label sequences, gesture timing, facial expression scores, and environmental information from the analysis unit, as well as user location information (e.g., GPS coordinates, Wi-Fi location estimation) and user profile information (e.g., residential region, native language, cultural background flag) as input. Examples of input include “sign language gestures recorded in the Kansai region of Japan”, “sign language gestures by a user from the West Coast of the United States”, “sign language gestures by a user with a French-speaking cultural background”, etc. The conversion unit inputs region and culture information as conditional variables into a multilingual and multicultural neural network (e.g., conditional Transformer Encoder-Decoder, LSTM with region embedding vectors) to generate natural language expressions optimized for each region and culture. For example, for the Kansai region sign language gesture “Arigatou”, the output may be the region-specific expression “Ookini”; for American Sign Language (ASL), the output may be the regionally colored English expression “Thanks, y'all”; for French Sign Language (LSF), the output may be the culturally nuanced French expression “Merci beaucoup”. Examples of output include “Japanese (Kansai dialect): Ookini”, “English (Southern dialect): Thanks, y'all”, “French (standard): Merci beaucoup”, etc. The conversion unit can automatically select or simultaneously output region-and culture-adaptive language output according to user settings and usage environment. During model training, the conversion unit uses region-and culture-annotated multilingual corpora, dialect and slang dictionaries, and cultural expression databases, combining cross-entropy loss functions, region adaptation loss, and cultural consistency loss to improve learning accuracy. By dynamically reflecting region and culture information, the conversion unit, unlike conventional standard language conversion or single-culture adaptation methods, can generate language expressions optimized for the user's social background and usage scene in real time. As a technical effect, the conversion unit realizes reduction of misunderstanding and discomfort, smooth communication, and improved international and multicultural accessibility through region-and culture-adaptive language conversion. Specific application fields include regional dialect instruction and multicultural education in educational settings, support for multinational patients in medical institutions, region-specific guidance in public facilities and transportation, multicultural sign language interpretation at international conferences, and video conferences with remote locations (region-and culture-adaptive automatic translation). In these fields, the present invention exhibits technical effects such as improved region and culture adaptability, expression diversity, and international accessibility in sign language verbalization.

The output unit can estimate the user's emotion and adjust the output method of voice or text based on the user's emotion. For example, the output unit estimates the user's emotion and adjusts the output method of voice or text based on the user's emotion. Emotion estimation is realized, for example, by using an emotion estimation function with an emotion engine or generative AI. Generative AI may be, for example, a text generation AI (such as LLM) or a multimodal generative AI, but is not limited to these examples. For instance, when the user is nervous, the output unit outputs in a calm voice. When the user is relaxed, the output unit can output in a bright voice. Furthermore, when the user is in a hurry, the output unit can output in a rapid and concise voice. Thus, the output unit can provide the optimal output method according to the user's emotion. Specifically, the output unit inputs natural language sentences and speech synthesis parameters (e.g., text, spectrum, pitch, speed) received from the conversion unit, as well as multimodal data such as facial expression images, voice data, and vital signs (e.g., heart rate, skin potential) received from the camera unit and analysis unit, into an emotion estimation neural network (e.g., multimodal Transformer, time-series LSTM). Examples of input include “facial expression images when nervous”, “voice waveforms with bright tone”, “time-series data of high heart rate”, etc. The output unit obtains emotion labels such as “nervous”, “relaxed”, “in a hurry” and probability distributions (e.g., nervous 0.80, relaxed 0.15, in a hurry 0.05) from the AI model, and dynamically adjusts output parameters of the speech synthesis module (e.g., WaveNet, Tacotron2) or text display module (e.g., voice tone, speed, volume, text color, font) accordingly. For example, when the nervousness is high, the output unit selects a low and calm tone of voice or soft-colored text; when the relaxation is high, outputs a bright and lively voice or colorful text; when in a hurry, generates concise and speedy voice or text. Examples of output include “Calm voice: low pitch, slow”, “Bright voice: high pitch, fast”, “Rapid voice: short sentence, high speed”, etc. The output unit reflects these output method adjustment results in real time to the speaker or display, realizing information transmission optimized for the user's emotional state. During model training, the output unit uses emotion-labeled voice and text corpora and output style annotation data, combining cross-entropy loss functions and style control loss to improve learning accuracy. As a technical effect, unlike conventional fixed output methods or manual adjustment by human operators, the output unit combines AI-based emotion estimation and dynamic output control to realize optimal voice and text output in real time according to the user's psychological state and situation. Specific application fields include output adjustment according to students' nervousness in educational settings, explanatory expressions according to patients' psychological state in medical institutions, guidance in public facilities and transportation (guidance expressions according to users' situations), multilingual sign language interpretation at international conferences (output optimization according to presenters' emotions), and video conferences with remote locations (dynamic response to changing situations). In these fields, the present invention exhibits technical effects such as adaptability of output, improvement of user experience, and communication efficiency in sign language verbalization.

The output unit can add a function to adjust the tone and speed of voice according to the user's preference in the case of voice output. For example, the output unit adds a function to adjust the tone and speed of voice according to the user's preference in the case of voice output. Tone and speed of voice may include, for example, pitch and speed range, but are not limited to these examples. The output unit can use AI to adjust the tone and speed of voice. For example, the output unit adjusts the tone of voice according to the user's preference. The output unit can also adjust the speed of voice according to the user's preference. Furthermore, the output unit can simultaneously adjust both the tone and speed of voice according to the user's preference. Thus, in the case of voice output, the output unit can adjust the tone and speed of voice according to the user's preference. Specifically, the output unit receives natural language sentences and speech synthesis parameters (e.g., text, spectrum, pitch, speed) from the conversion unit, as well as user profile information (e.g., age, gender, hearing characteristics, preferred voice quality, speech speed setting) and past voice output history as input. Examples of input include “elderly user prefers slow and low-pitched voice”, “young user prefers bright and fast tone”, “clear pronunciation for hearing-impaired users”, etc. The output unit dynamically adjusts parameters such as tone (e.g., high pitch, low pitch), speed (e.g., slow, fast), voice quality (e.g., male, female, neutral), and clarity (e.g., emphasized pronunciation) in an AI-based speech synthesis module (e.g., WaveNet, Tacotron2) according to the user's preference. For example, if the user prefers “slow and low-pitched”, the output unit lowers the pitch parameter and reduces the speech speed parameter to generate the voice waveform. If the user prefers “bright and fast tone”, the output unit raises the pitch and increases the speed to generate the voice. Examples of output include “low-pitched, slow voice”, “high-pitched, fast voice”, “clear pronunciation voice”, etc. The output unit sends these voice outputs to the speaker in real time, realizing voice information transmission optimized for the user's preference. During model training, the output unit uses voice corpora labeled with user preferences and parameter control annotation data, combining cross-entropy loss functions and preference adaptation loss to improve learning accuracy. As a technical effect, unlike conventional fixed voice output or manual adjustment methods, the output unit combines AI-based user preference estimation and dynamic parameter control to realize optimal voice output in real time according to diverse user needs and hearing characteristics. Specific application fields include individualized voice output in educational settings, explanatory voice according to patient characteristics in medical institutions, guidance voice according to user attributes in public facilities and transportation, voice interpretation for diverse participants at international conferences, and video conferences with remote locations (individually optimized voice output). In these fields, the present invention exhibits technical effects such as adaptability of voice output, improvement of user experience, and enhancement of accessibility in sign language verbalization.

The output unit can add a function to adjust the font and size of text according to the user's visual characteristics in the case of text output. For example, the output unit adds a function to adjust the font and size of text according to the user's visual characteristics in the case of text output. Font and size of text may include, for example, font type and size range, but are not limited to these examples. The output unit can use AI to adjust the font and size of text. For example, the output unit adjusts the font of text according to the user's visual characteristics. The output unit can also adjust the size of text according to the user's visual characteristics. Furthermore, the output unit can simultaneously adjust both the font and size of text according to the user's visual characteristics. Thus, in the case of text output, the output unit can adjust the font and size of text according to the user's visual characteristics. Specifically, the output unit receives natural language sentences and text display parameters (e.g., font type, size, color) from the conversion unit, as well as user profile information (e.g., age, visual acuity, color vision characteristics, preferred font, display magnification setting) and past text display history as input. Examples of input include “elderly user prefers large font”, “high-contrast color scheme for color-blind users”, “young user prefers casual font”, etc. The output unit uses an AI-based text display optimization module (e.g., conditional generation model, user-adaptive neural network) to dynamically adjust parameters such as font type (e.g., Gothic, Mincho, universal design font), size (e.g., 12 pt to 48 pt), color (e.g., black, white, yellow), and contrast (e.g., high, medium, low) according to the user's visual characteristics. For example, for users with poor eyesight, the output unit automatically selects large font and high-contrast color scheme; for color-blind users, color-corrected color scheme; for young users, preferred font. Examples of output include “large Gothic font, high contrast”, “standard size Mincho font, blue”, “casual font, yellow”, etc. The output unit displays these text outputs on the display in real time, realizing information transmission optimized for the user's visual characteristics. During model training, the output unit uses text display corpora labeled with visual characteristics and parameter control annotation data, combining cross-entropy loss functions and characteristic adaptation loss to improve learning accuracy. As a technical effect, unlike conventional fixed text display or manual adjustment methods, the output unit combines AI-based visual characteristic estimation and dynamic parameter control to realize optimal text output in real time according to diverse visual characteristics and preferences. Specific application fields include individualized text display in educational settings, explanatory display according to patient characteristics in medical institutions, guidance display according to user attributes in public facilities and transportation, text interpretation for diverse participants at international conferences, and video conferences with remote locations (individually optimized text output). In these fields, the present invention exhibits technical effects such as adaptability of text output, improvement of user experience, and enhancement of accessibility in sign language verbalization.

The output unit can estimate the user's emotion and adjust the output timing of voice or text based on the user's emotion. For example, the output unit estimates the user's emotion and adjusts the output timing of voice or text based on the user's emotion. Emotion estimation is realized, for example, by using an emotion estimation function with an emotion engine or generative AI. Generative AI may be, for example, a text generation AI (such as LLM) or a multimodal generative AI, but is not limited to these examples. For instance, when the user is nervous, the output unit delays the output timing of voice or text to make it easier to understand. When the user is relaxed, the output unit can advance the output timing to provide information quickly. Furthermore, when the user is in a hurry, the output unit can automatically adjust the output timing to provide information quickly. Thus, the output unit can provide the optimal output timing according to the user's emotion. Specifically, the output unit inputs natural language sentences and speech synthesis parameters (e.g., text, spectrum, pitch, speed) received from the conversion unit, as well as multimodal data such as facial expression images, voice data, and vital signs (e.g., heart rate, skin potential) received from the camera unit and analysis unit, into an emotion estimation neural network (e.g., multimodal Transformer, time-series LSTM). Examples of input include “facial expression images when nervous”, “voice waveforms with bright tone”, “time-series data of high heart rate”, etc. The output unit obtains emotion labels such as “nervous”, “relaxed”, “in a hurry” and probability distributions (e.g., nervous 0.80, relaxed 0.15, in a hurry 0.05) from the AI model, and dynamically adjusts output timing parameters of the speech synthesis module or text display module (e.g., speech start delay, text display delay, sequential output interval) accordingly. For example, when the nervousness is high, the output unit delays speech start by 0.5 seconds and displays text gradually to facilitate user understanding. When the relaxation is high, the output unit selects immediate output or fast scroll display to maximize information transmission speed. When in a hurry, the output unit dynamically optimizes output timing according to the user's gesture speed and speech content to provide necessary information in the shortest time. Examples of output include “Delayed output: speech start delayed by 0.5 seconds”, “Immediate output: real-time display”, “High-speed output: sequential output at 0.1-second intervals”, etc. The output unit reflects these output timing adjustment results in real time to the speaker or display, realizing information transmission optimized for the user's emotional state. During model training, the output unit uses emotion-labeled voice and text corpora and output timing control annotation data, combining cross-entropy loss functions and timing control loss to improve learning accuracy. As a technical effect, unlike conventional fixed output timing or manual adjustment by human operators, the output unit combines AI-based emotion estimation and dynamic timing control to realize optimal output timing of voice or text in real time according to the user's psychological state and situation. This enables improved understanding of information transmission, reduction of misunderstanding and stress, and individual optimization of user experience. Specific application fields include output timing adjustment according to students' nervousness in educational settings, explanation timing according to patients' psychological state in medical institutions, guidance timing according to users' situations in public facilities and transportation, output optimization according to presenters' emotions in multilingual sign language interpretation at international conferences, and dynamic response to changing situations in video conferences with remote locations. In these fields, the present invention exhibits technical effects such as adaptability of output timing, improvement of user experience, and communication efficiency in sign language verbalization.

The output unit can add a function to automatically adjust the volume of voice by considering environmental sounds around the user in the case of voice output. For example, the output unit adds a function to automatically adjust the volume of voice by considering environmental sounds around the user in the case of voice output. Environmental sounds may include, for example, surrounding noise or quiet environments, but are not limited to these examples. The output unit can use AI to adjust the volume of voice. For example, when the user's surroundings are noisy, the output unit automatically increases the volume of voice. When the user's surroundings are quiet, the output unit can automatically decrease the volume of voice. Furthermore, the output unit can automatically adjust the volume of voice according to environmental sounds around the user. Thus, in the case of voice output, the output unit can automatically adjust the volume of voice by considering environmental sounds around the user. Specifically, the output unit receives speech synthesis parameters (e.g., text, spectrum, pitch, speed) from the conversion unit, as well as environmental sound data (e.g., surrounding voice waveforms, noise level dB values, frequency spectrum) obtained from the camera unit or dedicated microphone as input. Examples of input include “voice waveform with high noise in a train station”, “low-noise environment in a quiet library”, “environmental sound with strong wind noise outdoors”, etc. The output unit uses an AI-based environmental sound analysis model (e.g., acoustic classification CNN, noise estimation RNN) to estimate the type of environmental sound (e.g., noise, silence, speech, traffic sound) and noise level (e.g., 60 dB, 30 dB) with high accuracy. Based on the estimation results, the output unit dynamically adjusts the volume parameters of the speech synthesis module (e.g., output volume dB, dynamic range, normalization coefficient). For example, when the noise level is high, the output unit increases the volume to 80 dB; in a quiet environment, decreases it to 40 dB, responding immediately to environmental changes. Examples of output include “High-noise environment: volume 80 dB”, “Silent environment: volume 40 dB”, “Moderate noise: volume 60 dB”, etc. The output unit reflects these voice volume adjustment results in real time to the speaker, enabling the user to obtain an optimal listening experience. During model training, the output unit uses voice corpora labeled with environmental sounds and noise level annotation data, combining cross-entropy loss functions and volume control loss to improve learning accuracy. As a technical effect, unlike conventional fixed volume output or manual adjustment methods, the output unit combines AI-based environmental sound estimation and dynamic volume control to realize optimal voice output in real time according to the user's usage environment. This greatly reduces difficulty in hearing in noisy environments and discomfort due to excessive volume in quiet environments, significantly improving user experience and accessibility. Specific application fields include voice guidance in noisy classrooms or quiet libraries in educational settings, environment-adaptive voice output for each patient in medical institutions, guidance voice according to user attributes in public facilities and transportation, voice optimization for various venue environments at international conferences, and automatic response to environmental sound changes in video conferences with remote locations. In these fields, the present invention exhibits technical effects such as adaptability of voice output, improvement of user experience, and enhancement of accessibility in sign language verbalization.

The output unit can select an optimal display method by considering the user's device information in the case of text output. For example, the output unit selects an optimal display method by considering the user's device information in the case of text output. Device information may include, for example, device screen size and resolution, but is not limited to these examples. The output unit can use AI to adjust the display method of text. For example, when the user is using a smartphone, the output unit provides a text display method adapted to the screen size. When the user is using a tablet, the output unit can provide a text display method optimized for a large screen. Furthermore, when the user is using a smartwatch, the output unit can provide a concise and highly visible text display method. Thus, in the case of text output, the output unit can select an optimal display method by considering the user's device information. Specifically, the output unit receives natural language sentences and text display parameters (e.g., font type, size, color) from the conversion unit, as well as user device information (e.g., device type, screen size, resolution, display magnification, OS version) and past display history as input. Examples of input include “5-inch smartphone”, “10-inch tablet”, “1.5-inch smartwatch”, etc. The output unit uses an AI-based device-adaptive text display optimization module (e.g., conditional generation model, neural network with device embedding vectors) to dynamically adjust parameters such as optimal font type (e.g., sans-serif, Mincho), size (e.g., 12 pt to 48 pt), line spacing, layout (e.g., single column, double column), and color (e.g., high contrast, dark mode) for each device. For example, on a smartphone, the output unit automatically selects a large font and simple layout; on a tablet, multi-column layout and insertion of charts; on a smartwatch, short sentences, high contrast, and icon-assisted display. Examples of output include “For smartphone: large sans-serif font, single column”, “For tablet: standard size Mincho font, double column”, “For smartwatch: short sentence, high contrast”, etc. The output unit reflects these text displays in real time on the device display, realizing information transmission optimized for the user's usage environment. During model training, the output unit uses text display corpora labeled with device type and parameter control annotation data, combining cross-entropy loss functions and device adaptation loss to improve learning accuracy. As a technical effect, unlike conventional fixed text display or manual adjustment methods, the output unit combines AI-based device information estimation and dynamic parameter control to realize optimal text output in real time according to diverse device environments and preferences. This prevents reduced visibility and information loss due to differences in screen size and resolution, greatly improving user experience and accessibility. Specific application fields include individualized text display in educational settings, explanatory display according to patient characteristics in medical institutions, guidance display according to user attributes in public facilities and transportation, text interpretation for diverse participants at international conferences, and device-optimized text output in video conferences with remote locations. In these fields, the present invention exhibits technical effects such as adaptability of text output, improvement of user experience, and enhancement of accessibility in sign language verbalization.

The system according to the embodiment is not limited to the examples described above and can be variously modified as follows, for example. Specifically, the system can be diversified, expanded, and optimized according to technical requirements and usage scenarios, including each component such as the camera unit, analysis unit, conversion unit, and output unit, AI model architecture, data flow, input/output specifications, parameter control methods, learning methods, user adaptation functions, multimodal processing, real-time assurance means, security and privacy protection functions, network cooperation methods, cloud/edge distributed processing configuration, battery management, inter-device cooperation, additional sensors, external API cooperation, user interface design, log recording and analysis functions, fault detection and self-repair functions, and more. The system can flexibly respond to technical improvements and creation of new use cases, such as types of AI models (e.g., CNN, RNN, Transformer, GNN, etc.), expansion of learning datasets (e.g., multilingual, multicultural, multi-environment data), granularity of user profiles, trade-off control between real-time performance and accuracy, large-scale data analysis via cloud cooperation, low-latency processing by edge devices, acquisition of new features by adding sensors, and functional expansion by API cooperation with external systems. As a technical effect, unlike conventional fixed and single-function systems, the present system allows for various technical variations in components, AI models, data flow, user interfaces, etc., enabling optimization, expansion, and evolution according to the usage site and user needs, and can comprehensively improve the accuracy, speed, adaptability, expandability, accessibility, maintainability, and security of sign language recognition, verbalization, and output. Specific application fields include educational settings, medical institutions, public facilities, transportation, international conferences, remote communication, multicultural society, support for people with disabilities, industrial sites, and home IoT cooperation, and the technical effects of the present invention are exhibited in all fields, environments, and user groups.

The analysis unit can improve recognition accuracy by referring to the user's past sign language history when recognizing sign language movements. For example, the analysis unit learns sign language movements previously used by the user and refers to that history when recognizing similar movements to improve recognition accuracy. The analysis unit can also predict sign language movements based on the user's past sign language history to improve recognition accuracy. Furthermore, the analysis unit can analyze the user's past sign language history to recognize sign language movements more quickly. Thus, by referring to the user's past sign language history, the analysis unit can improve recognition accuracy. Specifically, the analysis unit refers to a database of sign language gesture data recorded in time series for each user (e.g., a structured database containing sign language gesture frames for the past month, sign language word label sequences, gesture start/end timing, facial expression scores, environmental information, etc.). Input data includes current sign language gesture tensors (e.g., float arrays of frame count×21×3), facial expression images, and voice data received from the camera unit. The analysis unit compares these current input data with past history data, uses a similarity calculation module (e.g., cosine similarity, dynamic time warping (DTW), feature space distance calculation) to identify frequently occurring gesture patterns and expression patterns in the past. For example, if the input is “raising the right hand and touching the thumb and index finger”, and there are multiple records of similar gestures in the past history, the analysis unit refers to that history to increase the recognition confidence of the “Hello” label. The analysis unit learns user-specific gesture habits and expression tendencies (e.g., habitual hand angles, individual differences in gesture speed, degree of emphasis in facial expressions) with an AI model (e.g., user-adaptive Transformer, personalized RNN), and applies personalized weights and biases during inference. Examples of output include “Sign language word label: Thank you (user history reference confidence 0.95)”, “Gesture segment: frames 10-25”, “History match score: 0.92”, etc. The analysis unit sends recognition results based on history reference to the conversion unit, contributing to improved accuracy in subsequent natural language conversion and speech synthesis processing. During model training, the analysis unit adds user-specific history data as training data (fine-tuning), combining cross-entropy loss functions and history match loss for optimization. As a technical effect, unlike conventional generic models or non-history reference methods, the analysis unit utilizes individual user history with high accuracy, greatly reducing recognition errors due to individual differences and realizing individual optimization of recognition accuracy, speed, and user experience. Specific application fields include individualized sign language learning support in educational settings (recognition according to each student's progress and habits), communication with patients in medical institutions (adaptation to patients' unique gesture patterns), support for regular users in public facilities and transportation (improved recognition accuracy based on usage history), multilingual sign language interpretation at international conferences (optimization according to presenters' expression tendencies), and video conferences with remote locations (reduction of recognition errors by history reference). In these fields, the present invention exhibits technical effects such as individual optimization, improved accuracy, and enhanced real-time performance in sign language recognition and verbalization.

The conversion unit can use language expressions corresponding to the user's region or culture when converting sign language movements into language. For example, when the user is in Japan, the conversion unit uses expressions specific to Japanese culture or region to convert sign language movements into language. When the user is in the United States, the conversion unit can use expressions specific to American culture or region to convert sign language movements into language. Furthermore, when the user is in France, the conversion unit can use expressions specific to French culture or region to convert sign language movements into language. Thus, by using language expressions corresponding to the user's region or culture, the conversion unit can provide more appropriate language conversion. Specifically, the conversion unit receives time-series data such as sign language word label sequences, gesture timing, facial expression scores, and environmental information from the analysis unit, as well as user location information (e.g., GPS coordinates, Wi-Fi location estimation) and user profile information (e.g., residential region, native language, cultural background flag) as input. Examples of input include “sign language gestures recorded in the Kansai region of Japan”, “sign language gestures by a user from the West Coast of the United States”, “sign language gestures by a user with a French-speaking cultural background”, etc. The conversion unit inputs region and culture information as conditional variables into a multilingual and multicultural neural network (e.g., conditional Transformer Encoder-Decoder, LSTM with region embedding vectors) to generate natural language expressions optimized for each region and culture. For example, for the Kansai region sign language gesture “Arigatou”, the output may be the region-specific expression “Ookini”; for American Sign Language (ASL), the output may be the regionally colored English expression “Thanks, y'all”; for French Sign Language (LSF), the output may be the culturally nuanced French expression “Merci beaucoup”. Examples of output include “Japanese (Kansai dialect): Ookini”, “English (Southern dialect): Thanks, y'all”, “French (standard): Merci beaucoup”, etc. The conversion unit can automatically select or simultaneously output region-and culture-adaptive language output according to user settings and usage environment. During model training, the conversion unit uses region-and culture-annotated multilingual corpora, dialect and slang dictionaries, and cultural expression databases, combining cross-entropy loss functions, region adaptation loss, and cultural consistency loss to improve learning accuracy. By dynamically reflecting region and culture information, the conversion unit, unlike conventional standard language conversion or single-culture adaptation methods, can generate language expressions optimized for the user's social background and usage scene in real time. As a technical effect, the conversion unit realizes reduction of misunderstanding and discomfort, smooth communication, and improved international and multicultural accessibility through region-and culture-adaptive language conversion. Specific application fields include regional dialect instruction and multicultural education in educational settings, support for multinational patients in medical institutions, region-specific guidance in public facilities and transportation, multicultural sign language interpretation at international conferences, and video conferences with remote locations (region-and culture-adaptive automatic translation). In these fields, the present invention exhibits technical effects such as improved region and culture adaptability, expression diversity, and international accessibility in sign language verbalization.

The output unit can add a function to automatically adjust the volume of voice by considering environmental sounds around the user in the case of voice output. For example, when the user's surroundings are noisy, the output unit automatically increases the volume of voice. When the user's surroundings are quiet, the output unit can automatically decrease the volume of voice. Furthermore, the output unit can automatically adjust the volume of voice according to environmental sounds around the user. Thus, in the case of voice output, the output unit can automatically adjust the volume of voice by considering environmental sounds around the user. Specifically, the output unit receives speech synthesis parameters (e.g., text, spectrum, pitch, speed) from the conversion unit, as well as environmental sound data (e.g., surrounding voice waveforms, noise level dB values, frequency spectrum) obtained from the camera unit or dedicated microphone as input. Examples of input data include “voice waveform with high noise in a train station”, “low-noise environment in a quiet library”, “environmental sound with strong wind noise outdoors”, etc. The output unit uses an AI-based environmental sound analysis model (e.g., acoustic classification CNN, noise estimation RNN) to estimate the type of environmental sound (e.g., noise, silence, speech, traffic sound) and noise level (e.g., 60 dB, 30 dB) with high accuracy. Inputs to the AI model include, for example, a one-second voice waveform (sampling rate 16 kHz, 16,000-sample float array), spectrogram image (128×128 two-dimensional tensor), and time-series vector of noise level (10 elements). Outputs from the AI model include environmental sound labels (e.g., “noise”, “silence”), noise level scores (e.g., 0.85), and estimated dB values (e.g., 65 dB). Examples of output include “Environmental sound label: noise, noise level: 0.85, estimated volume: 65 dB” and “Environmental sound label: silence, noise level: 0.10, estimated volume: 30 dB”. Based on the estimation results, the output unit dynamically adjusts the volume parameters of the speech synthesis module (e.g., output volume dB, dynamic range, normalization coefficient). For example, when the noise level is high, the output unit increases the volume to 80 dB; in a quiet environment, decreases it to 40 dB, responding immediately to environmental changes. The output unit reflects these voice volume adjustment results in real time to the speaker, enabling the user to obtain an optimal listening experience. In subsequent processing, the speech synthesis module generates the voice waveform with the adjusted parameters and sends it to the speaker output. As a technical effect, unlike conventional fixed volume output or manual adjustment methods, the output unit combines AI-based environmental sound estimation and dynamic volume control to realize optimal voice output in real time according to the user's usage environment. This greatly reduces difficulty in hearing in noisy environments and discomfort due to excessive volume in quiet environments, significantly improving user experience and accessibility. Specific application fields include voice guidance in noisy classrooms or quiet libraries in educational settings, environment-adaptive voice output for each patient in medical institutions, guidance voice according to user attributes in public facilities and transportation, voice optimization for various venue environments at international conferences, and automatic response to environmental sound changes in video conferences with remote locations. In these fields, the present invention exhibits technical effects such as adaptability of voice output, improvement of user experience, and enhancement of accessibility in sign language verbalization.

The output unit can select an optimal display method by considering the user's device information in the case of text output. For example, when the user is using a smartphone, the output unit provides a text display method adapted to the screen size. When the user is using a tablet, the output unit can provide a text display method optimized for a large screen. Furthermore, when the user is using a smartwatch, the output unit can provide a concise and highly visible text display method. Thus, in the case of text output, the output unit can select an optimal display method by considering the user's device information. Specifically, the output unit receives natural language sentences and text display parameters (e.g., font type, size, color) from the conversion unit, as well as user device information (e.g., device type, screen size, resolution, display magnification, OS version) and past display history as input. Examples of input include “5-inch smartphone”, “10-inch tablet”, “1.5-inch smartwatch”, etc. The output unit uses an AI-based device-adaptive text display optimization module (e.g., conditional generation model, neural network with device embedding vectors) to dynamically adjust parameters such as optimal font type (e.g., sans-serif, Mincho), size (e.g., 12 pt to 48 pt), line spacing, layout (e.g., single column, double column), and color (e.g., high contrast, dark mode) for each device. Inputs to the AI model include device type ID (e.g., smartphone=1, tablet=2, smartwatch=3), screen size (e.g., 5.0 inches), resolution (e.g., 1080×1920), and user preference parameters (e.g., preference for large text=1), and outputs are optimized display parameter sets (e.g., font=sans-serif, size=24 pt, color=white, layout=single column). Examples of output include “For smartphone: large sans-serif font, single column”, “For tablet: standard size Mincho font, double column”, “For smartwatch: short sentence, high contrast”, etc. The output unit reflects these text displays in real time on the device display, realizing information transmission optimized for the user's usage environment. In subsequent processing, the display control module draws the text with the received parameters so that the user can immediately view it. As a technical effect, unlike conventional fixed text display or manual adjustment methods, the output unit combines AI-based device information estimation and dynamic parameter control to realize optimal text output in real time according to diverse device environments and preferences. This prevents reduced visibility and information loss due to differences in screen size and resolution, greatly improving user experience and accessibility. Specific application fields include individualized text display in educational settings, explanatory display according to patient characteristics in medical institutions, guidance display according to user attributes in public facilities and transportation, text interpretation for diverse participants at international conferences, and device-optimized text output in video conferences with remote locations. In these fields, the present invention exhibits technical effects such as adaptability of text output, improvement of user experience, and enhancement of accessibility in sign language verbalization.

The camera unit can add a filtering function to reduce background noise when capturing sign language movements. For example, the camera unit uses the filtering function to remove background noise. The camera unit can also use the filtering function to remove background movements. Furthermore, the camera unit can use the filtering function to adjust background colors. Thus, by removing background noise, the camera unit can capture sign language movements in detail. Specifically, the camera unit receives high-resolution RGB images or video frames (e.g., 1920×1080 pixels, 30 fps) as input data and inputs them into an AI model for background removal (e.g., semantic segmentation U-Net, background subtraction CNN, conditional GAN). Examples of input include “an image of a person performing sign language in a classroom with desks and chairs in the foreground”, “video frames with passersby in the background outdoors”, etc. The camera unit uses the AI model to output a label map for each pixel such as “sign language gesture area” and “background area”, and applies masking or blurring to the pixel values of the background area. Examples of output include “sign language gesture area mask image”, “background-blurred image”, “background color-adjusted image”, etc. The camera unit sends the background-removed image as an image tensor for sign language gesture analysis (e.g., frame count×channel count×height×width) to the analysis unit. During AI model training, the camera unit uses annotated image datasets with and without background, combining cross-entropy loss functions and region matching loss to improve accuracy. Unlike conventional simple chroma key processing or manual masking by human operators, the camera unit realizes high-precision background separation, noise reduction, and color optimization in real time using deep learning, enabling clear capture of fine movements and changes in finger shapes in sign language gestures. As a technical effect, the camera unit reduces misrecognition due to background noise or movement, greatly improving sign language recognition accuracy, analysis accuracy, and real-time performance. Specific application fields include sign language learning support in educational settings (classroom environments with background noise), communication with patients in medical institutions (background removal in hospital rooms), guidance in public facilities and transportation (extraction of sign language gestures in crowded environments), multilingual sign language interpretation at international conferences (adaptation to diverse background environments), and video conferences with remote locations (background optimization in homes, offices, outdoors). In these fields, the present invention exhibits technical effects such as improved accuracy, speed, and adaptability in sign language recognition and verbalization.

The camera unit can estimate the user's emotion and adjust the camera's shooting angle based on the estimated emotion of the user. For example, when the user is nervous, the camera unit widens the shooting angle to capture sign language movements over a broader area. When the user is relaxed, the camera unit narrows the shooting angle to capture sign language movements in detail. Furthermore, when the user is in a hurry, the camera unit can automatically adjust the shooting angle to quickly capture sign language movements. Thus, the camera unit can provide the optimal shooting angle according to the user's emotion. Specifically, the camera unit inputs the user's facial images and vital sign sensor data (e.g., heart rate sensor, skin potential sensor) obtained from face detection sensors and vital sign sensors mounted on the camera, as well as voice data and time-series vectors of vital signs (e.g., 10-second heart rate array), into an emotion estimation neural network (e.g., multimodal Transformer, time-series LSTM). Examples of input include “facial expression images when nervous”, “fast speech waveforms”, “time-series data of high heart rate”, etc. The AI model outputs emotion labels (e.g., “nervous”, “relaxed”, “in a hurry”) and probability distributions (e.g., nervous 0.80, relaxed 0.15, in a hurry 0.05). According to the emotion estimation results, the camera unit dynamically adjusts parameters of the pan/tilt/zoom control module (e.g., angle of view, zoom ratio, shooting center coordinates). For example, when the nervousness is high, the camera unit widens the angle of view to 90 degrees; when the relaxation is high, increases the zoom ratio to focus on the hands; when in a hurry, increases the pan/tilt speed to enhance motion tracking. Examples of output include “Wide-angle shooting: angle of view 90 degrees”, “Narrow-angle shooting: zoom 2.0×”, “Auto tracking: pan speed 30 degrees/sec”, etc. The camera unit reflects these shooting angle adjustment results in real time and sends the captured images or videos to the analysis unit. As a technical effect, unlike conventional fixed angles or manual adjustment methods, the camera unit combines AI-based emotion estimation and dynamic shooting angle control to realize optimal shooting range, resolution, and motion tracking in real time according to the user's psychological state and situation. This enables both overall grasp and detailed observation of sign language gestures, greatly improving recognition accuracy, user experience, and analysis speed. Specific application fields include wide-angle shooting for nervous students in educational settings, shooting optimization according to patients' psychological state in medical institutions, adjustment of shooting range according to users' situations in public facilities and transportation, shooting optimization according to presenters' emotions in multilingual sign language interpretation at international conferences, and dynamic response to changing situations in video conferences with remote locations. In these fields, the present invention exhibits technical effects such as adaptability of shooting, improvement of user experience, and enhancement of real-time performance in sign language recognition and verbalization.

The analysis unit can estimate the user's emotion and adjust the analysis accuracy of sign language movements based on the user's emotion. For example, when the user is nervous, the analysis unit increases the analysis accuracy to analyze sign language movements in detail. When the user is relaxed, the analysis unit can decrease the analysis accuracy to analyze sign language movements quickly. Furthermore, when the user is in a hurry, the analysis unit can automatically adjust the analysis accuracy to analyze sign language movements quickly. Thus, the analysis unit can adjust the analysis accuracy according to the user's emotion. Specifically, the analysis unit inputs multimodal data such as the user's facial images, voice data, and vital signs (e.g., heart rate, skin potential) received from the camera unit into an emotion estimation neural network (e.g., multimodal Transformer, time-series LSTM), and outputs emotion labels (e.g., “nervous”, “relaxed”, “in a hurry”) and probability distributions (e.g., nervous 0.80, relaxed 0.15, in a hurry 0.05). Examples of input include “facial expression images when nervous”, “fast speech waveforms”, “time-series data of high heart rate”, etc. Based on the emotion estimation results, the analysis unit dynamically adjusts parameters of the sign language gesture analysis module (e.g., kernel size of convolutional layers, time-series window width, feature extraction threshold, dropout rate during inference, etc.). For example, when the nervousness is high, the analysis unit reduces the kernel size of convolutional layers and widens the time-series window to extract more detailed features and reduce misrecognition. When the relaxation is high, the analysis unit relaxes the feature extraction threshold and switches to parameter settings that prioritize inference speed. When in a hurry, the analysis unit increases the dropout rate during inference to speed up processing, automatically optimizing the balance between analysis accuracy and speed. The analysis unit reflects these parameter adjustment results in the sign language gesture recognition model (e.g., CNN, RNN, Transformer) and controls analysis accuracy in real time. Examples of output include “Sign language word label in high-accuracy mode”, “Gesture timing estimation in high-speed mode”, etc. The analysis unit sends the adjusted analysis results to the conversion unit, contributing to improved accuracy in subsequent language conversion and speech synthesis processing. As a technical effect, unlike conventional fixed parameter methods or manual adjustment by human operators, the analysis unit uses AI to estimate the user's emotional state with high accuracy and automatically optimizes analysis accuracy accordingly, thereby reducing errors in sign language recognition, improving real-time performance, and realizing individual optimization of user experience. Specific application fields include sign language learning support in educational settings (accuracy-prioritized mode for nervous students), communication with patients in medical institutions (analysis speed adjustment according to situation), guidance in public facilities and transportation (high-speed analysis during crowded times), optimization according to presenters' psychological state in multilingual sign language interpretation at international conferences, and dynamic response to changing situations in video conferences with remote locations. In these fields, the present invention exhibits technical effects such as improved accuracy, speed, and adaptability in sign language recognition and verbalization.

The conversion unit is capable of estimating the user's emotion and adjusting the method of expression when converting sign language movements into language based on the user's emotion. For example, when the user is nervous, the conversion unit uses a simple method of expression to convert sign language movements into language. When the user is relaxed, the conversion unit can use a detailed method of expression to convert sign language movements into language. Furthermore, when the user is in a hurry, the conversion unit can use a rapid method of expression to convert sign language movements into language. In this way, the conversion unit can provide the optimal method of expression according to the user's emotion. Specifically, the conversion unit receives sign language motion data (e.g., sign language word label sequences, motion timing, facial expression scores, speech speed information, etc.) from the camera unit and analysis unit, as well as emotion labels (e.g., “nervous,” “relaxed,” “in a hurry”) and probability distributions (e.g., nervous 0.80, relaxed 0.15, in a hurry 0.05) output from an emotion estimation neural network (e.g., multimodal Transformer, time-series LSTM). Examples of input include “facial expression images when nervous,” “fast speech waveforms,” and “high heart rate time-series data.” The conversion unit dynamically adjusts generation parameters (e.g., level of detail in output sentences, sentence length, vocabulary selection, expression style) in a natural language generation module (e.g., Transformer Encoder-Decoder, conditional LSTM) according to the emotion label. For example, when the nervousness level is high, the conversion unit prioritizes short and concise expressions (e.g., “yes,” “no”), and when the relaxation level is high, it generates detailed explanations and polite expressions (e.g., “Good morning. Thank you for your cooperation today”). When the user is in a hurry, the conversion unit selects expressions that quickly convey only the main points (e.g., “Departing,” “Arrived”). Examples of output include “simple expression: thank you,” “detailed expression: thank you for your cooperation today,” and “rapid expression: understood.” The conversion unit sends these expression adjustment results to a speech synthesis module or text output module, thereby realizing language output optimized for the user's emotional state. During model training, the conversion unit uses emotion-labeled corpora and expression style annotation data, combining cross-entropy loss functions and style control loss to improve learning accuracy. As a technical effect, unlike conventional fixed expression methods or manual expression adjustment by human operators, the conversion unit combines AI-based emotion estimation and dynamic expression control to generate optimal language expressions in real time according to the user's psychological state and situation. Specific application fields include sign language learning support in educational settings (expression adjustment according to students' nervousness), communication with patients in medical institutions (explanatory expressions according to patients' psychological state), guidance in public facilities and transportation (guidance expressions according to users' situations), multilingual sign language interpretation at international conferences (expression optimization according to presenters' emotions), and video conferences with remote locations (dynamic response to changing situations). In these fields, the present invention demonstrates technical effects such as adaptability of sign language expression, improvement of user experience, and increased communication efficiency.

The output unit is capable of estimating the user's emotion and adjusting the method of outputting voice or text based on the user's emotion. For example, when the user is nervous, the output unit outputs in a calm voice. When the user is relaxed, the output unit can output in a bright voice. Furthermore, when the user is in a hurry, the output unit can output in a rapid and concise voice. In this way, the output unit can provide the optimal output method according to the user's emotion. Specifically, the output unit inputs natural language sentences and speech synthesis parameters (e.g., text, spectrum, pitch, speed) received from the conversion unit, as well as multimodal data such as facial expression images, voice data, and vital signs (e.g., heart rate, skin potential) received from the camera unit and analysis unit, into an emotion estimation neural network (e.g., multimodal Transformer, time-series LSTM). Examples of input include “facial expression images when nervous,” “voice waveforms with a bright tone,” and “high heart rate time-series data.” The output unit obtains emotion labels such as “nervous,” “relaxed,” “in a hurry,” and probability distributions (e.g., nervous 0.80, relaxed 0.15, in a hurry 0.05) from the AI model, and dynamically adjusts output parameters of the speech synthesis module (e.g., WaveNet, Tacotron2) and text display module (e.g., voice tone, speed, volume, text color, font) according to these. For example, when the nervousness level is high, the output unit selects a low and calm tone of voice or soft-colored text; when the relaxation level is high, it outputs a bright and lively voice or colorful text; and when the user is in a hurry, it generates concise and speedy voice or text. Examples of output include “calm voice: low pitch, slow,” “bright voice: high pitch, fast,” and “rapid voice: short sentence, high speed.” The output unit reflects these output method adjustment results in real time to the speaker or display, thereby realizing information transmission optimized for the user's emotional state. During model training, the output unit uses emotion-labeled voice and text corpora and output style annotation data, combining cross-entropy loss functions and style control loss to improve learning accuracy. As a technical effect, unlike conventional fixed output methods or manual adjustment by human operators, the output unit combines AI-based emotion estimation and dynamic output control to realize optimal voice and text output in real time according to the user's psychological state and situation. Specific application fields include output adjustment according to students' nervousness in educational settings, explanatory expressions according to patients' psychological state in medical institutions, guidance in public facilities and transportation (guidance expressions according to users' situations), multilingual sign language interpretation at international conferences (output optimization according to presenters' emotions), and video conferences with remote locations (dynamic response to changing situations). In these fields, the present invention demonstrates technical effects such as adaptability of sign language output, improvement of user experience, and increased communication efficiency.

The output unit is capable of estimating the user's emotion and adjusting the timing of outputting voice or text based on the user's emotion. For example, when the user is nervous, the output unit delays the timing of voice or text output to make it easier to understand. When the user is relaxed, the output unit can advance the timing of voice or text output to provide information quickly. Furthermore, when the user is in a hurry, the output unit can automatically adjust the timing of voice or text output to provide information rapidly. In this way, the output unit can provide the optimal output timing according to the user's emotion. Specifically, the output unit inputs natural language sentences and speech synthesis parameters (e.g., text, spectrum, pitch, speed) received from the conversion unit, as well as multimodal data such as facial expression images, voice data, and vital signs (e.g., heart rate, skin potential) received from the camera unit and analysis unit, into an emotion estimation neural network (e.g., multimodal Transformer, time-series LSTM). Examples of input include “facial expression images when nervous,” “voice waveforms with a bright tone,” and “high heart rate time-series data.” The output unit obtains emotion labels such as “nervous,” “relaxed,” “in a hurry,” and probability distributions (e.g., nervous 0.80, relaxed 0.15, in a hurry 0.05) from the AI model, and dynamically adjusts output timing parameters of the speech synthesis module and text display module (e.g., speech start delay, text display delay, sequential output interval) according to these. For example, when the nervousness level is high, the output unit delays speech start by 0.5 seconds and displays text gradually to promote user understanding. When the relaxation level is high, the output unit selects immediate output or fast scroll display to maximize information transmission speed. When the user is in a hurry, the output unit dynamically optimizes output timing according to the user's movement speed and speech content to provide necessary information in the shortest possible time. Examples of output include “delayed output: speech start delayed by 0.5 seconds,” “immediate output: real-time display,” and “fast output: sequential output at 0.1-second intervals.” The output unit reflects these output timing adjustment results in real time to the speaker or display, thereby realizing information transmission optimized for the user's emotional state. During model training, the output unit uses emotion-labeled voice and text corpora and output timing control annotation data, combining cross-entropy loss functions and timing control loss to improve learning accuracy. As a technical effect, unlike conventional fixed output timing or manual adjustment by human operators, the output unit combines AI-based emotion estimation and dynamic timing control to realize optimal voice and text output timing in real time according to the user's psychological state and situation. This enables improved understanding of information transmission, reduction of misunderstandings and stress, and individualized optimization of user experience. Specific application fields include output timing adjustment according to students' nervousness in educational settings, explanation timing according to patients' psychological state in medical institutions, guidance in public facilities and transportation (guidance timing according to users' situations), multilingual sign language interpretation at international conferences (output optimization according to presenters' emotions), and video conferences with remote locations (dynamic response to changing situations). In these fields, the present invention demonstrates technical effects such as adaptability of sign language output timing, improvement of user experience, and increased communication efficiency.

The following is a brief description of the processing flow of Example of the Embodiment. Specifically, in this system, each component—the camera unit, analysis unit, conversion unit, and output unit—operates in cooperation. The camera unit simultaneously acquires high-resolution RGB images or video frames of sign language movements (e.g., 1920×1080 pixels, 30 fps), voice waveforms, and environmental sensor data (e.g., time-series vectors of temperature, humidity, and illuminance), and inputs these as time-series tensors into an environmental information extraction module. The camera unit uses object detection models (e.g., YOLO-based CNN), audio event detection models (e.g., CNN for acoustic classification), and environmental feature extraction algorithms to extract object labels such as “chair” and “desk” from images, event labels such as “conversation” and “noise” from audio, and environmental states such as “bright” and “quiet” from sensor values. The analysis unit inputs multimodal data such as sign language motion tensors, facial expression images, voice data, and vital signs received from the camera unit into an emotion estimation neural network (e.g., multimodal Transformer, time-series LSTM), and outputs emotion labels and probability distributions. Based on the emotion estimation results, the analysis unit dynamically adjusts parameters of the sign language motion analysis module (e.g., kernel size of convolutional layers, time-series window width, feature extraction thresholds, dropout rate during inference) and reflects them in the sign language motion recognition model (e.g., CNN, RNN, Transformer). The conversion unit receives time-series data such as sign language word label sequences, motion timing, facial expression scores, and environmental information from the analysis unit, and uses a context analysis module (e.g., bidirectional LSTM, Transformer Encoder-Decoder) to integrate preceding and following movements, facial expressions, and environmental information, and evaluates contextual consistency and semantic relevance. Based on context and semantic information, the conversion unit dynamically adjusts natural language generation parameters (e.g., word order, tense, negative/interrogative expressions, insertion of modifiers, vocabulary selection) and generates optimal natural language sentences. The output unit, in addition to natural language sentences and speech synthesis parameters received from the conversion unit, considers the user's emotion, environmental sounds, and device information, and dynamically adjusts output parameters of the speech synthesis module and text display module (e.g., voice tone, speed, volume, font, color, display timing). The output unit reflects these outputs in real time to the speaker or display, thereby realizing information transmission optimized for the user's emotional state and usage environment. As a technical effect, unlike conventional simple sign language recognition and conversion systems, this system combines dynamic control adapted to environment, emotion, and context by multimodal AI, thereby greatly improving the accuracy, speed, adaptability, and accessibility of sign language recognition, language conversion, and output.

Step 1: The camera unit captures sign language movements. Sign language movements include hand shape, position, speed, direction, and so on. The camera unit can capture hand movements in detail with high resolution, accurately capturing fine finger movements and changes in hand position. Step 2: The analysis unit uses AI to analyze the video captured by the camera unit. The analysis unit recognizes sign language movements in real time and converts each sign language gesture into a corresponding language. Real time means allowing a delay of only a few milliseconds. Step 3: The conversion unit uses AI to convert sign language movements recognized by the analysis unit into language. The language includes Japanese, English, text format, and voice format. The conversion unit uses algorithms that improve conversion accuracy by considering the context and meaning of sign language, and accurately converts sign language movements into language. Step 4: The output unit outputs the language converted by the conversion unit as voice or text. In the case of voice output, the output unit outputs voice from a speaker mounted on glasses; in the case of text output, the output unit displays text on a display of the glasses. The output unit is equipped with a function to adjust the tone and speed of voice according to the user's preference. Specifically, in Step 1, the camera unit simultaneously acquires RGB images, depth images, voice waveforms, and environmental sensor data, and performs AI-based filtering processing for background removal and noise reduction. In Step 2, the analysis unit inputs multimodal data such as sign language motion tensors, facial expression images, voice data, and vital signs into an emotion estimation neural network (e.g., multimodal Transformer, time-series LSTM), and outputs emotion labels and probability distributions. Based on the emotion estimation results, the analysis unit dynamically adjusts parameters of the sign language motion analysis module (e.g., kernel size of convolutional layers, time-series window width, feature extraction thresholds, dropout rate during inference) and reflects them in the sign language motion recognition model (e.g., CNN, RNN, Transformer). In Step 3, the conversion unit receives time-series data such as sign language word label sequences, motion timing, facial expression scores, and environmental information from the analysis unit, and uses a context analysis module (e.g., bidirectional LSTM, Transformer Encoder-Decoder) to integrate preceding and following movements, facial expressions, and environmental information, and evaluates contextual consistency and semantic relevance. Based on context and semantic information, the conversion unit dynamically adjusts natural language generation parameters (e.g., word order, tense, negative/interrogative expressions, insertion of modifiers, vocabulary selection) and generates optimal natural language sentences. In Step 4, the output unit, in addition to natural language sentences and speech synthesis parameters received from the conversion unit, considers the user's emotion, environmental sounds, and device information, and dynamically adjusts output parameters of the speech synthesis module and text display module (e.g., voice tone, speed, volume, font, color, display timing). The output unit reflects these outputs in real time to the speaker or display, thereby realizing information transmission optimized for the user's emotional state and usage environment. As a technical effect, unlike conventional simple sign language recognition and conversion systems, this system combines dynamic control adapted to environment, emotion, and context by multimodal AI, thereby greatly improving the accuracy, speed, adaptability, and accessibility of sign language recognition, language conversion, and output.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described camera unit, analysis unit, conversion unit, and output unit is implemented by at least one of, for example, a smart device 14 and a data processing apparatus 12. For example, the camera unit is implemented by a camera 42 of the smart device 14 and captures sign language movements in detail with high resolution. The analysis unit is implemented, for example, by a specific processing unit 290 of the data processing apparatus 12 and recognizes sign language movements in real time using AI. The conversion unit is implemented, for example, by the specific processing unit 290 of the data processing apparatus 12 and converts sign language movements into a corresponding language. The output unit is implemented, for example, by an output device 40 of the smart device 14 and outputs as voice or text. The correspondence between each unit and the device or control unit is not limited to the above examples and various modifications are possible.

### Second Embodiment

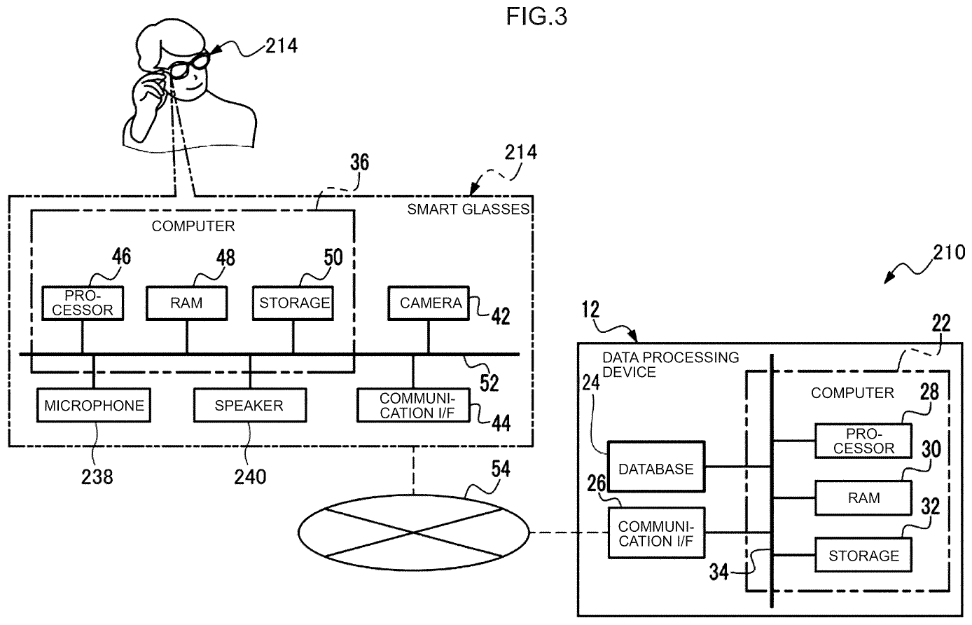

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

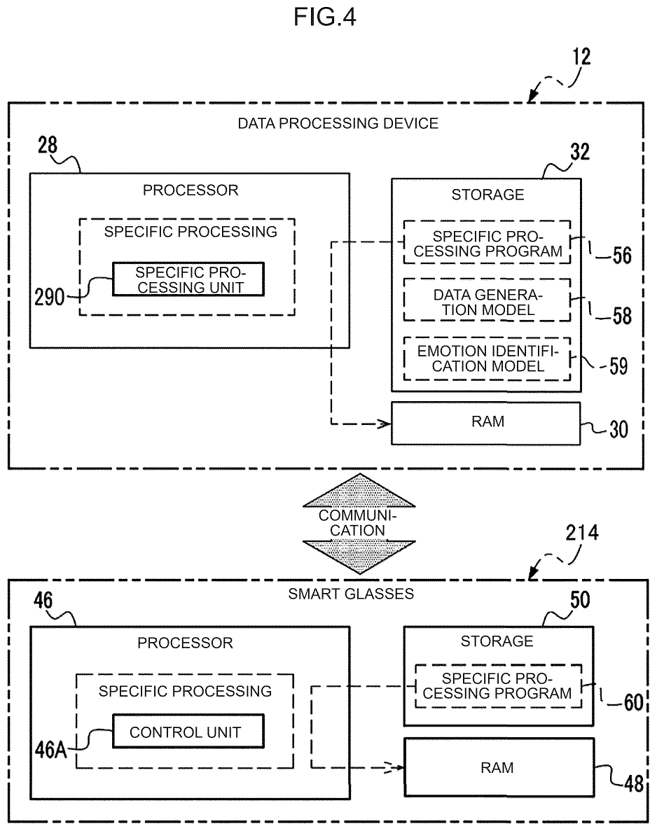

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described camera unit, analysis unit, conversion unit, and output unit is implemented by at least one of, for example, smart glasses 214 and a data processing apparatus 12. For example, the camera unit is implemented by a camera 42 of the smart glasses 214 and captures sign language movements in detail with high resolution. The analysis unit is implemented, for example, by a specific processing unit 290 of the data processing apparatus 12 and recognizes sign language movements in real time using AI. The conversion unit is implemented, for example, by the specific processing unit 290 of the data processing apparatus 12 and converts sign language movements into a corresponding language. The output unit is implemented, for example, by a speaker 240 and a display of the smart glasses 214 and outputs as voice or text. The correspondence between each unit and the device or control unit is not limited to the above examples and various modifications are possible.

### Third Embodiment

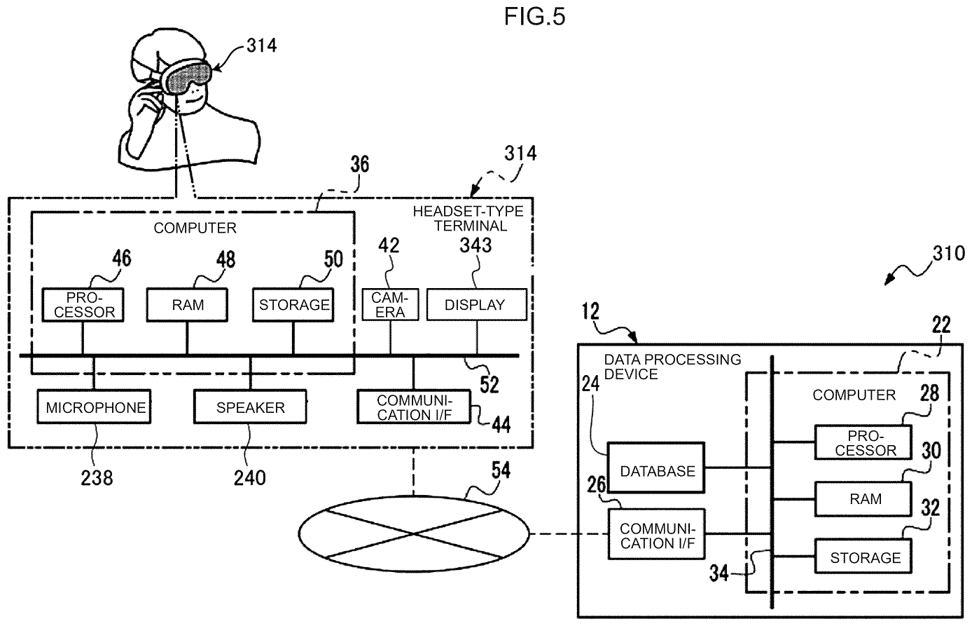

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

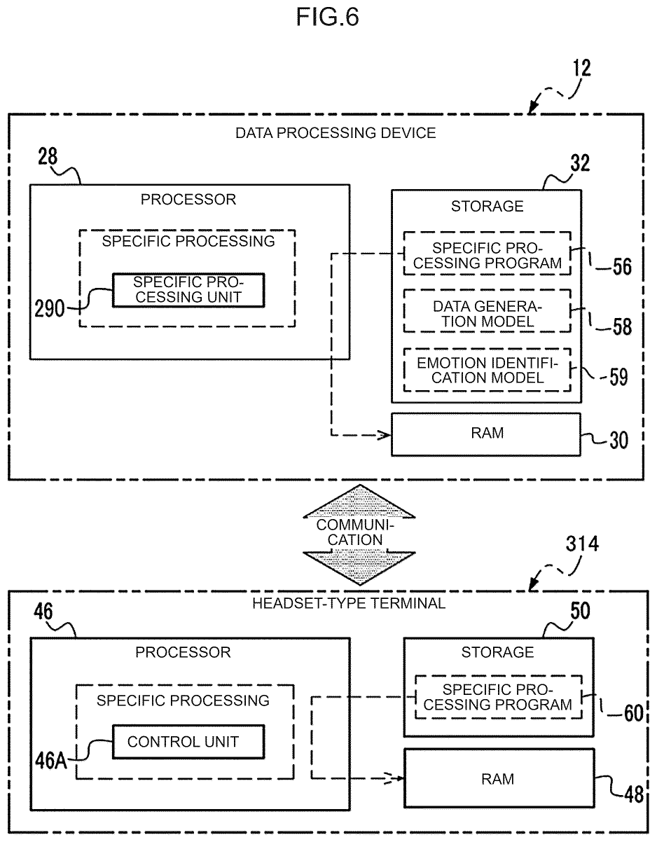

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described camera unit, analysis unit, conversion unit, and output unit is implemented by at least one of, for example, a headset-type terminal 314 and a data processing apparatus 12. For example, the camera unit is implemented by a camera 42 of the headset-type terminal 314 and captures sign language movements in detail with high resolution. The analysis unit is implemented, for example, by a specific processing unit 290 of the data processing apparatus 12 and recognizes sign language movements in real time using AI. The conversion unit is implemented, for example, by the specific processing unit 290 of the data processing apparatus 12 and converts sign language movements into a corresponding language. The output unit is implemented, for example, by a speaker 240 and a display 343 of the headset-type terminal 314 and outputs as voice or text. The correspondence between each unit and the device or control unit is not limited to the above examples and various modifications are possible.

### Fourth Embodiment

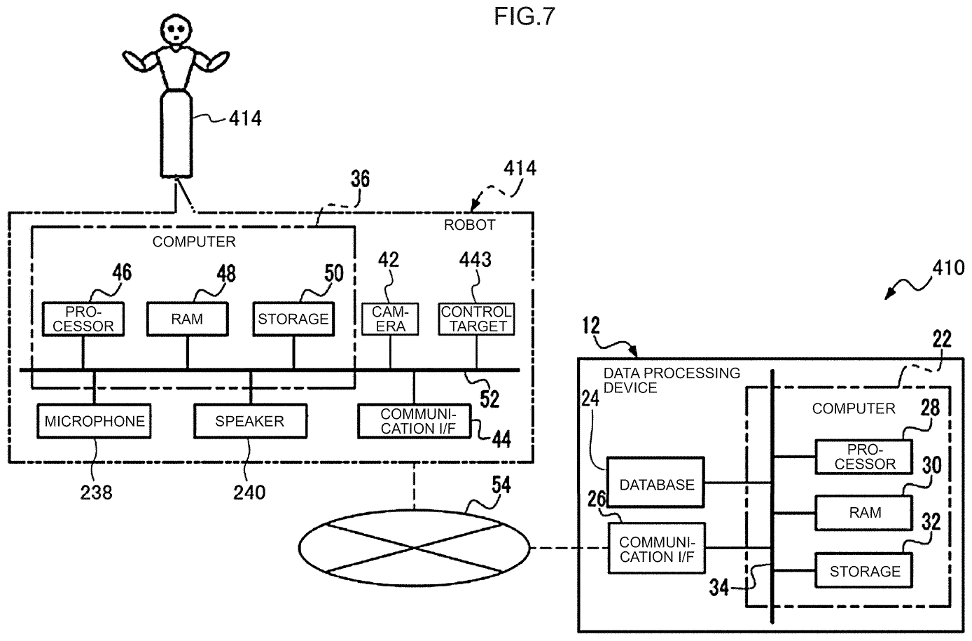

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

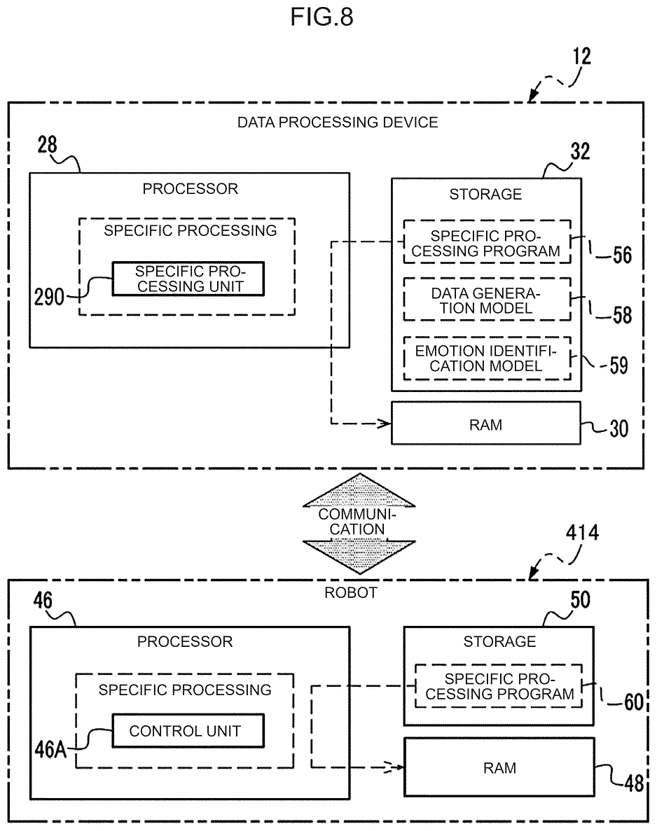

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described camera unit, analysis unit, conversion unit, and output unit is implemented by at least one of, for example, a robot 414 and a data processing apparatus 12. For example, the camera unit is implemented by a camera 42 of the robot 414 and captures sign language movements in detail with high resolution. The analysis unit is implemented, for example, by a specific processing unit 290 of the data processing apparatus 12 and recognizes sign language movements in real time using AI. The conversion unit is implemented, for example, by the specific processing unit 290 of the data processing apparatus 12 and converts sign language movements into a corresponding language. The output unit is implemented, for example, by a speaker 240 and a display of the robot 414 and outputs as voice or text. The correspondence between each unit and the device or control unit is not limited to the above examples and various modifications are possible.

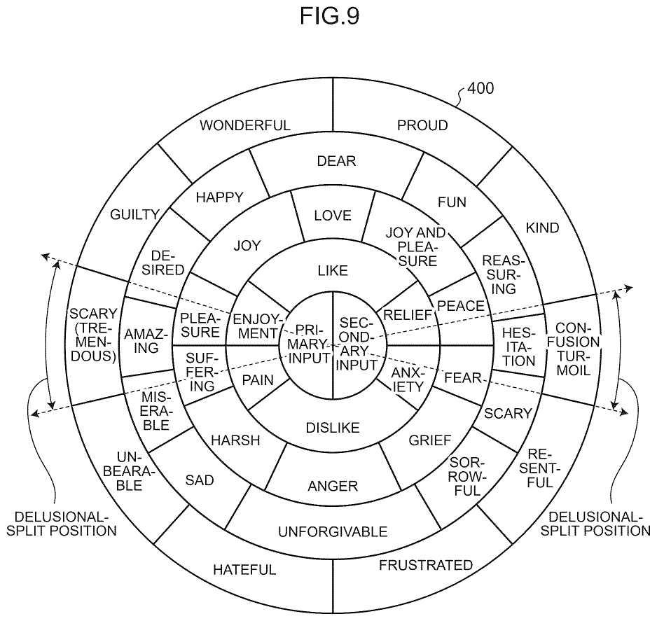

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

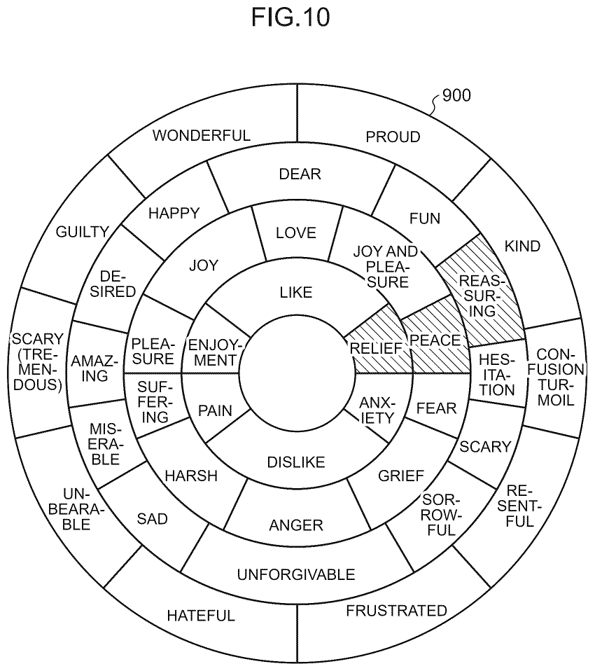

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a camera unit configured to capture sign language movements; an analysis unit configured to analyze video captured by the camera unit; a conversion unit configured to convert sign language movements recognized by the analysis unit into language; and an output unit configured to output the language converted by the conversion unit as voice or text.

(Supplementary Note 2) The system according to Supplementary Note 1, wherein the analysis unit is configured to recognize sign language movements in real time.

(Supplementary Note 3) The system according to Supplementary Note 1, wherein the conversion unit is configured to convert each sign language gesture into a corresponding language.

(Supplementary Note 4) The system according to Supplementary Note 1, wherein, in the case of voice output, the output unit is configured to output voice from a speaker mounted on glasses.

(Supplementary Note 5) The system according to Supplementary Note 1, wherein, in the case of text output, the output unit is configured to display text on a display of the glasses.

(Supplementary Note 6) The system according to Supplementary Note 1, wherein the camera unit is configured to capture hand movements in detail with high accuracy.

(Supplementary Note 7) The system according to Supplementary Note 1, wherein the camera unit is configured to estimate a user's emotion and adjust the camera's shooting angle based on the estimated emotion of the user.

(Supplementary Note 8) The system according to Supplementary Note 1, wherein the camera unit uses a plurality of cameras to capture sign language movements in order to capture the speed or direction of hand movements in detail.

(Supplementary Note 9) The system according to Supplementary Note 1, wherein the camera unit is provided with a filtering function to reduce background noise when capturing sign language movements.

(Supplementary Note 10) The system according to Supplementary Note 1, wherein the camera unit is configured to estimate a user's emotion and adjust the camera's shooting timing based on the user's emotion.

(Supplementary Note 11) The system according to Supplementary Note 1, wherein the camera unit is configured to simultaneously capture the user's facial expressions when capturing sign language movements, thereby supplementing the meaning of the sign language.

(Supplementary Note 12) The system according to Supplementary Note 1, wherein the camera unit is configured to simultaneously acquire environmental information around the user when capturing sign language movements, thereby understanding the context of the sign language.

(Supplementary Note 13) The system according to Supplementary Note 1, wherein the analysis unit is configured to estimate a user's emotion and adjust the analysis accuracy of sign language movements based on the user's emotion.

(Supplementary Note 14) The system according to Supplementary Note 1, wherein the analysis unit uses an algorithm for detailed analysis of changes in hand shape and position when analyzing sign language movements.

(Supplementary Note 15) The system according to Supplementary Note 1, wherein the analysis unit is configured to improve analysis accuracy by considering the grammar and structure of sign language when analyzing sign language movements.

(Supplementary Note 16) The system according to Supplementary Note 1, wherein the analysis unit is configured to estimate a user's emotion and adjust the analysis speed of sign language movements based on the user's emotion.

(Supplementary Note 17) The system according to Supplementary Note 1, wherein the analysis unit is configured to simultaneously analyze the user's facial expressions and mouth movements when analyzing sign language movements, thereby supplementing the meaning of the sign language.

(Supplementary Note 18) The system according to Supplementary Note 1, wherein the analysis unit is configured to refer to the user's past sign language history to improve analysis accuracy when analyzing sign language movements.

(Supplementary Note 19) The system according to Supplementary Note 1, wherein the conversion unit is configured to estimate a user's emotion and adjust the expression method when converting sign language movements into language based on the user's emotion.

(Supplementary Note 20) The system according to Supplementary Note 1, wherein the conversion unit is configured to improve conversion accuracy by considering the context and meaning of sign language when converting sign language movements into language.

(Supplementary Note 21) The system according to Supplementary Note 1, wherein the conversion unit is provided with a multilingual conversion function to support conversion into a plurality of languages when converting sign language movements into language.

(Supplementary Note 22) The system according to Supplementary Note 1, wherein the conversion unit is configured to estimate a user's emotion and adjust the speed of conversion when converting sign language movements into language based on the user's emotion.

(Supplementary Note 23) The system according to Supplementary Note 1, wherein the conversion unit is configured to refer to the user's past sign language history to improve conversion accuracy when converting sign language movements into language.

(Supplementary Note 24) The system according to Supplementary Note 1, wherein the conversion unit is configured to use language expressions corresponding to the user's region or culture when converting sign language movements into language.

(Supplementary Note 25) The system according to Supplementary Note 1, wherein the output unit is configured to estimate a user's emotion and adjust the output method of voice or text based on the user's emotion.

(Supplementary Note 26) The system according to Supplementary Note 1, wherein, in the case of voice output, the output unit is provided with a function to adjust the tone and speed of voice according to the user's preference.

(Supplementary Note 27) The system according to Supplementary Note 1, wherein, in the case of text output, the output unit is provided with a function to adjust the font and size of text according to the user's visual characteristics.

(Supplementary Note 28) The system according to Supplementary Note 1, wherein the output unit is configured to estimate a user's emotion and adjust the output timing of voice or text based on the user's emotion.

(Supplementary Note 29) The system according to Supplementary Note 1, wherein, in the case of voice output, the output unit is provided with a function to automatically adjust the volume of voice by considering environmental sounds around the user.

(Supplementary Note 30) The system according to Supplementary Note 1, wherein, in the case of text output, the output unit is configured to select an optimal display method by considering the user's device information.

What is claimed is:

1. A system comprising:
circuitry configured to:
acquire image frame data representing gesture movements captured by an image sensor;
extract feature data from the image frame data by inputting the image frame data into a neural network;
generate natural language data by inputting the feature data into a data generation model, the data generation model converting the feature data into a natural language representation; and
output the natural language data as at least one of audio data or text data.

2. The system according to claim 1, wherein the circuitry is configured to extract the feature data and generate the natural language data in real time.

3. The system according to claim 1, wherein the gesture movements comprise sign language movements including hand shape, hand position, and hand movement direction.

4. The system according to claim 1, wherein the circuitry is configured to extract, from the image frame data, landmark coordinate data comprising a plurality of landmark vectors, each landmark vector representing three-dimensional position coordinates of a respective point on a hand of a user.

5. The system according to claim 4, wherein the circuitry is configured to arrange the landmark coordinate data as a time-series tensor and input the time-series tensor into the neural network.

6. The system according to claim 1, wherein the neural network comprises at least one of a convolutional neural network, a recurrent neural network, or a Transformer architecture with a self-attention mechanism.

7. The system according to claim 1, wherein the circuitry is configured to input the feature data into a multi-class classifier to obtain a gesture label and gesture timing data for each frame of the image frame data.

8. The system according to claim 7, wherein the data generation model comprises a context analysis module configured to receive a sequence of gesture labels and generate the natural language data by integrating preceding and following gesture labels with facial expression information.

9. The system according to claim 1, wherein the circuitry is configured to, when outputting the natural language data as audio data, input the natural language data into a speech synthesis module to generate an audio waveform with adjustable pitch and speed parameters.

10. The system according to claim 1, wherein the circuitry is configured to, when outputting the natural language data as text data, transmit the text data to a display of a wearable device for real-time display.

11. The system according to claim 1, wherein the circuitry is further configured to estimate an emotion of a user by inputting multimodal sensor data into an emotion identification model, and adjust a parameter of at least one of the neural network or the data generation model based on the estimated emotion.

12. The system according to claim 1, wherein the image sensor comprises a plurality of cameras positioned at different angles, and the circuitry is configured to integrate image data from the plurality of cameras using a three-dimensional reconstruction algorithm to calculate three-dimensional trajectory vectors of the gesture movements.

13. The system according to claim 1, wherein the circuitry is further configured to apply a background separation model to the image frame data to extract a foreground region corresponding to the gesture movements and reduce background noise before extracting the feature data.

14. The system according to claim 1, wherein the circuitry is further configured to extract facial expression data and mouth movement data from the image frame data, and input the facial expression data and the mouth movement data together with the feature data into the data generation model to supplement meaning of the gesture movements.

15. The system according to claim 1, wherein the circuitry is further configured to compare the feature data with stored historical gesture data of a user using a similarity calculation to adjust a recognition confidence of the feature data.

16. The system according to claim 1, wherein the circuitry is further configured to extract grammatical structure from a sequence of gesture labels using a grammar analysis module, and apply an automatic correction algorithm to evaluate semantic consistency of the sequence before generating the natural language data.

17. The system according to claim 1, wherein the circuitry is further configured to receive location information and cultural profile information of a user, and input the location information and the cultural profile information as conditional variables into the data generation model to generate the natural language data in a language expression corresponding to a region or culture of the user.

18. A system comprising:
a communication interface configured to communicate with a client terminal via a packet-switched network;
a processor;
a random-access memory; and
a memory storing a neural network, a data generation model, and an emotion identification model, wherein
the processor is configured to execute a program stored in the memory on the random-access memory to operate as circuitry configured to:
receive, from the client terminal via the communication interface, image frame data representing gesture movements captured by an image sensor of the client terminal, the image sensor comprising a complementary metal-oxide-semiconductor image sensor having a resolution of at least 1920 by 1080 pixels and a frame rate of at least 60 frames per second;
extract landmark coordinate data from the image frame data, the landmark coordinate data comprising 21-point landmark vectors each having x, y, and z coordinates representing three-dimensional positions of points on a hand of a user;
arrange the landmark coordinate data as a time-series tensor and input the time-series tensor into the neural network to extract feature data comprising motion patterns, speed vectors, and shape changes;
input the feature data into a multi-class classifier to obtain a gesture label and gesture timing data for each frame;
estimate an emotion of the user by inputting multimodal sensor data comprising facial image data, voice data, and vital sign data into the emotion identification model to obtain an emotion label and a probability distribution;
generate natural language data by inputting a sequence of gesture labels, facial expression information, and the emotion label into the data generation model comprising a context analysis module; and
transmit, to the client terminal via the communication interface, output data based on the natural language data for presentation as at least one of audio output or text display.

19. The system according to claim 18, wherein the circuitry is further configured to dynamically adjust an inference speed parameter of the neural network based on the emotion label, the inference speed parameter comprising at least one of a batch size, an inference thread count, or a dropout rate.

20. A method performed by circuitry of a system, the method comprising:
acquiring image frame data representing gesture movements captured by an image sensor;
extracting feature data from the image frame data by inputting the image frame data into a neural network;
generating natural language data by inputting the feature data into a data generation model, the data generation model converting the feature data into a natural language representation; and
outputting the natural language data as at least one of audio data or text data.
